(19) United States
(12) Patent Application Publication
(10) Pub. No.: US 2020/0341832 A1
(43) Pub. Date: Oct. 29, 2020

(54) PROCESSES THAT DETERMINE STATES OF SYSTEMS OF A DISTRIBUTED COMPUTING SYSTEM

(71) Applicant: VMware, Inc., Palo Alto, CA (US)

(72) Inventors: Arnak Poghosyan, Yerevan (AM); Ashot Nshan Harutyunyan, Yerevan (AM); Naira Movses Grigoryan, Yerevan (AM)

(73) Assignee: VMware, Inc., Palo Alto, CA (US)

(21) Appl. No.: 16/391,702

(22) Filed: Apr. 23, 2019

(51) Int. Cl. G06F 11/07; G06F 11/32; G06F 17/18; G06K 9/62

(52) U.S. Cl. CPC G06F 11/0793; G06F 11/327; G06F 2201/835; G06K 9/6267; G06F 17/18

(57) ABSTRACT

Automated processes and systems that determine a state of a complex computational system of a distributed computing system are described. The processes and systems determine outlier and normal metric values of metrics associated with a complex computational system. A total outlier metric is constructed based on the outlier and normal metric values of the metrics. Time stamps of outlier and normal total outlier metric values of the total outlier metric are labeled. Each time-stamp label identifies a normal or abnormal state of the complex computation system. One or more rules for classifying normal and abnormal states of the complex computational system are computed based on the time-stamp labels. The rules are applied to run-time metric values to determine a state of the complex computational system and generate an alert when the state is abnormal. The type of alert and corresponding abnormal state may be used to execute remedial measures.

### TECHNICAL FIELD

This disclosure is directed to processes and systems that determine and characterize states of systems of a distributed computing system.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems with numerous components that provide enormous computational bandwidths and data-storage capacities. These large, distributed computing systems are made possible by advances in computer networking, distributed operating systems and applications, data-storage appliances, computer hardware, and software technologies.

Because distributed computing systems have an enormous number of computational resources, various management systems have been developed to collect performance information about the resources. For example, a typical management system may collect hundreds of thousands, or millions, of streams of metric data, called “metrics,” that are used to evaluate the performance of a data center infrastructure. Each metric value of a metric may represent an amount of a resource in use at a point in time. The metrics contain information that may potentially be used to determine performance abnormalities within the distributed computing system. However, the enormous number of metric data streams received by management systems makes it extremely difficult for information technology (“IT”) administrators to monitor the metrics, detect performance abnormalities in real time, and respond in real time to performance abnormalities. Moreover, the extremely large number of metrics create a computational bottleneck for typical management systems, which delays detection of performance abnormalities. Failure to respond quickly to performance problems can interrupt services and have enormous cost implications for data center tenants, such as when a tenant's server applications stop running or fail to timely respond to client requests.

### SUMMARY

Automated processes and systems described herein are directed to determining states of complex computational systems of a distributed computing system. A complex computational system may be a collection of physical and/or virtual objects. Physical objects include server computers, data storage devices, and network devices. Virtual objects include virtual machines, containers, and applications. A single complex computational system may have hundreds of thousands, or millions, of associated metrics that are used to monitor resource usage, network usage, number of data stores, and response times, just to name a few. Processes and systems determine outlier and normal metric values of metrics associated with a complex computational system and recorded in a historical time window. A total outlier metric is constructed based on the outlier and normal metric values. Time stamps of outlier and normal total outlier metric values of the total outlier metric are labeled. Each time-stamp label identifies a normal or abnormal state of the complex computation system over the historical time window. One or more rules for classifying normal and abnormal states of the complex computational system over the historical time window are computed based on the metrics and the time-stamp labels. The rules are applied to run-time metric values of the metrics to determine a state of the complex computational system and generate an alert when the state indicates abnormal. The type of alert may be used to determine and execute remedial measures.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIG. 14A shows a plot of an example metric represented as a sequence of time series data associated with a resource of a distributed computing system.

FIGS. 14B-14C show examples of metrics transmitted from physical and virtual objects of a distributed computing system to a monitoring server.

FIGS. 15A-15B show plots of example non-constant and constant metrics over time.

FIG. 16A shows plots of three examples of unsynchronized metrics over the same time interval.

FIG. 16B shows a plot of metric values synchronized to a general set of uniformly spaced time stamps.

FIGS. 17A-17D show an example of obtaining a detrended and seasonally adjusted metric.

FIG. 18A shows a plot of an example metric with normally distributed metric values over a historical time window.

FIG. 18B shows normal and outlier metric values for the example metric in FIG. 18A.

FIG. 19A shows a plot of an example metric and forecast metric values.

FIG. 19B shows upper and lower bounds for the forecast metric values shown in FIG. 19A.

FIG. 19C shows outlier and normal metric values.

FIGS. 20A-20C show an example of a total outlier metric determined from two metrics.

FIG. 21 shows a plot of a metric.

FIGS. 22-24 show example plots of different total outlier metrics and time-stamp labels.

FIG. 25 shows an example of a decision tree technique used to generate a decision-tree model.

FIGS. 26 show an example of a decision-tree model.

FIGS. 27A-27B show an example of a rule associated with three metrics.

FIGS. 28A shows three example rules output from a decision tree technique.

FIG. 28B shows an example of rules applied to run-time metric values.

FIG. 29 shows an example graph of operations executed in response to a rule violation.

FIG. 30 shows an example graph of operations that may be executed in response to different combinations of rule violations.

FIG. 31 is a flow diagram illustrating an example implementation of a method that determines a state of a complex computational system of a distributed computing system.

FIG. 32 is flow diagram illustrating an example implementation of the “determine outlier and normal metric values of the metrics” step referred to in FIG. 31.

FIG. 33 is a flow diagram illustrating an example implementation of the “apply data preparation to the metrics” step referred to in block 3201 of FIG. 32.

FIG. 34 is a flow diagram of an example implementation of the “construct a total outlier metric based on the outlier and normal metric values” step referred to in FIG. 31.

FIG. 35 is a flow diagram of an example implementation of the “label time stamps of outlier and normal total outlier metric values” step referred to in FIG. 31.

FIG. 36 is a flow diagram of an example implementation of the “apply the rules to run-time metric values of the metrics to determine a run-time state of the complex computational system” step referred to in FIG. 31.

### DETAILED DESCRIPTION

This disclosure is directed to automated computational processes and systems to determine the state of a complex computational system of a distributed computing system. In a first subsection, computer hardware, complex computational systems, and virtualization are described. Automated processes and systems for determining the state of a complex computational system are described below in a second subsection.

### Computer Hardware, Computational Systems, and Virtualization

The term “abstraction” is not, in any way, intended to mean or suggest an abstract idea or concept. Computational abstractions are tangible, physical interfaces that are implemented using physical computer hardware, data-storage devices, and communications systems. Instead, the Willi “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that “software implemented” functionality is provided. The digitally encoded computer instructions are a physical control component of processor-controlled machines and devices. Multi-cloud aggregations, cloud-computing services, virtual-machine containers and virtual machines, containers, communications interfaces, and many of the other topics discussed below are tangible, physical components of physical, electro-optical-mechanical computer systems.

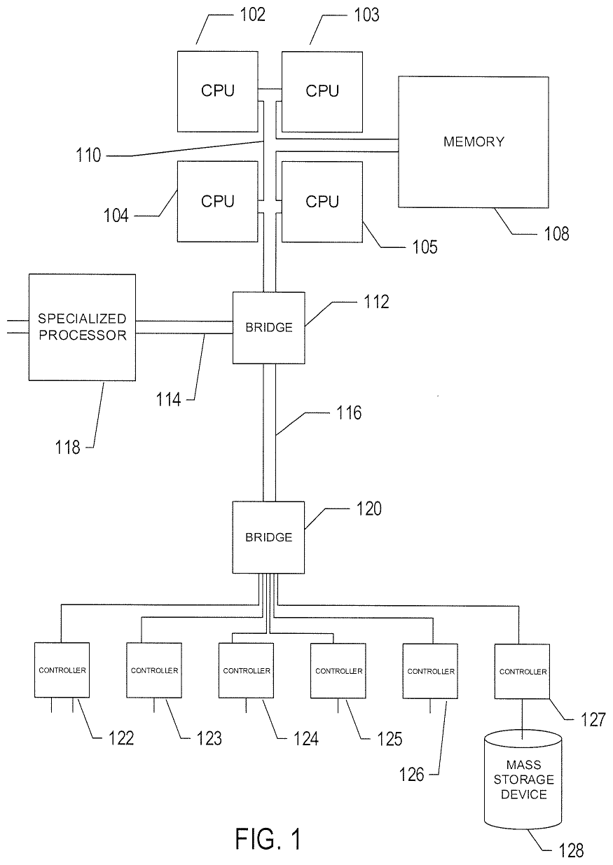

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

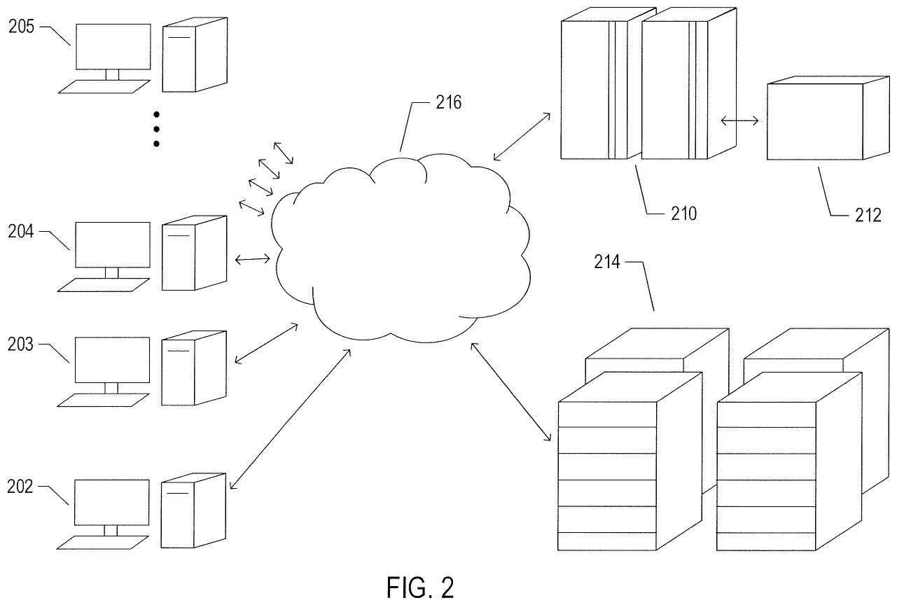

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which many PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

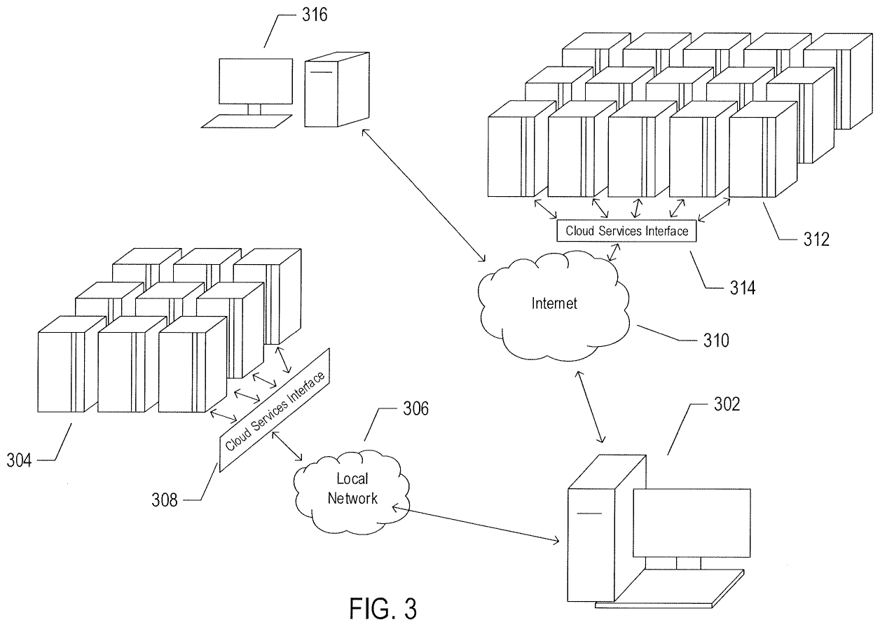

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

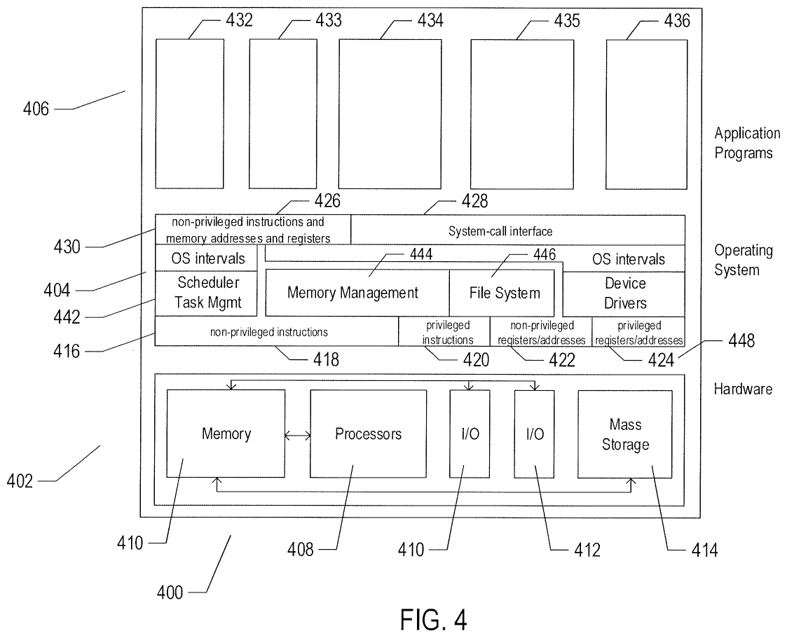

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

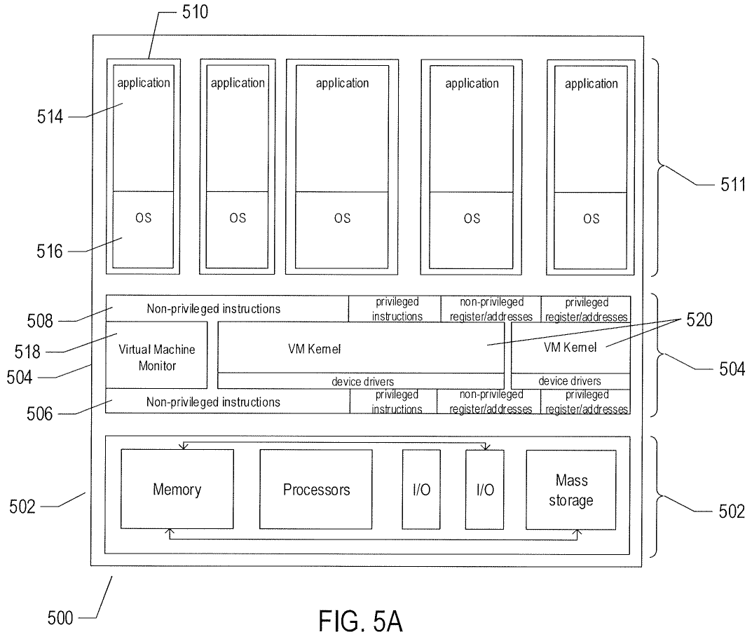

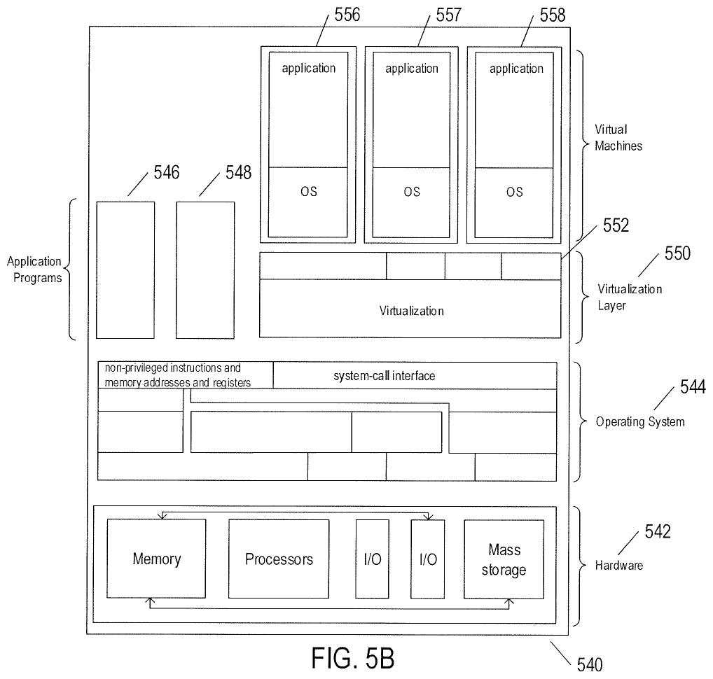

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

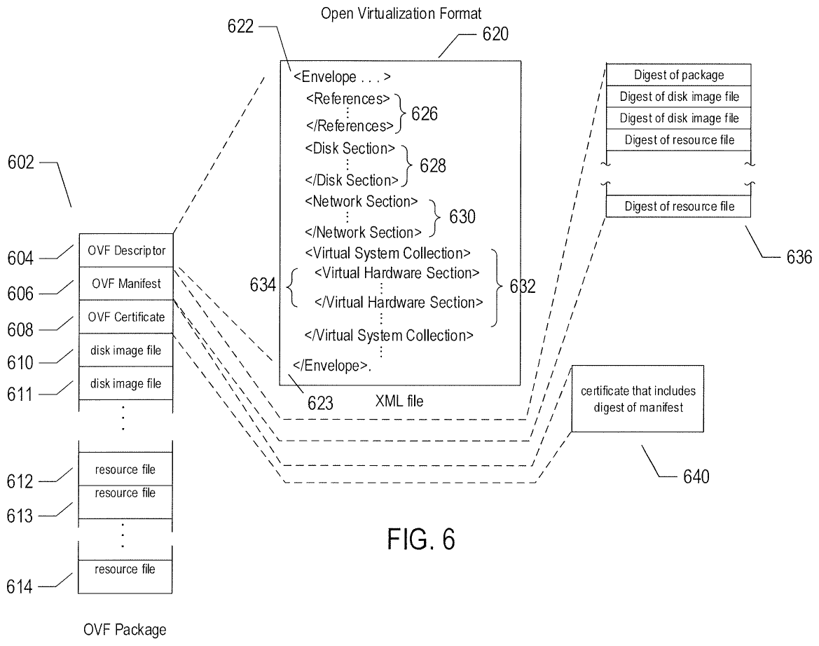

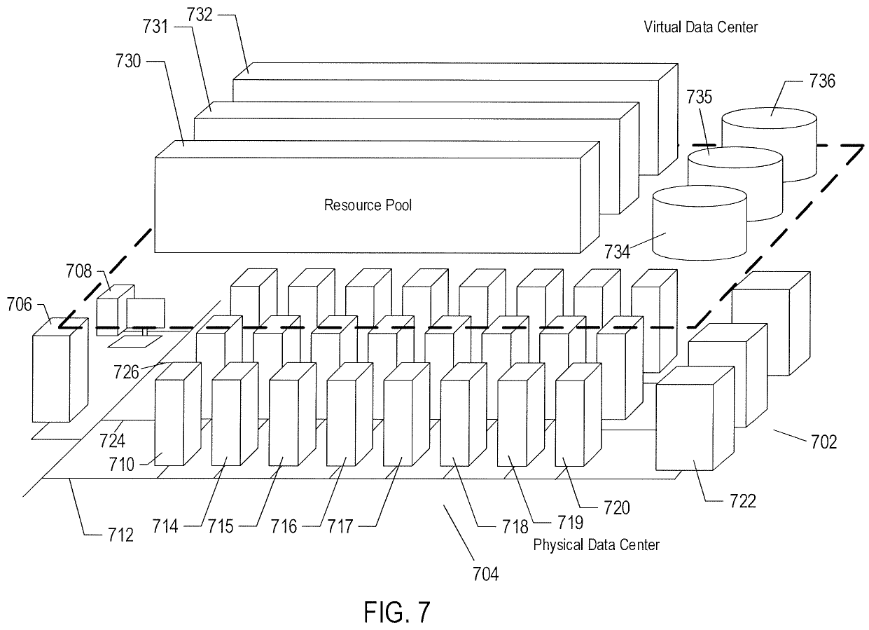

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

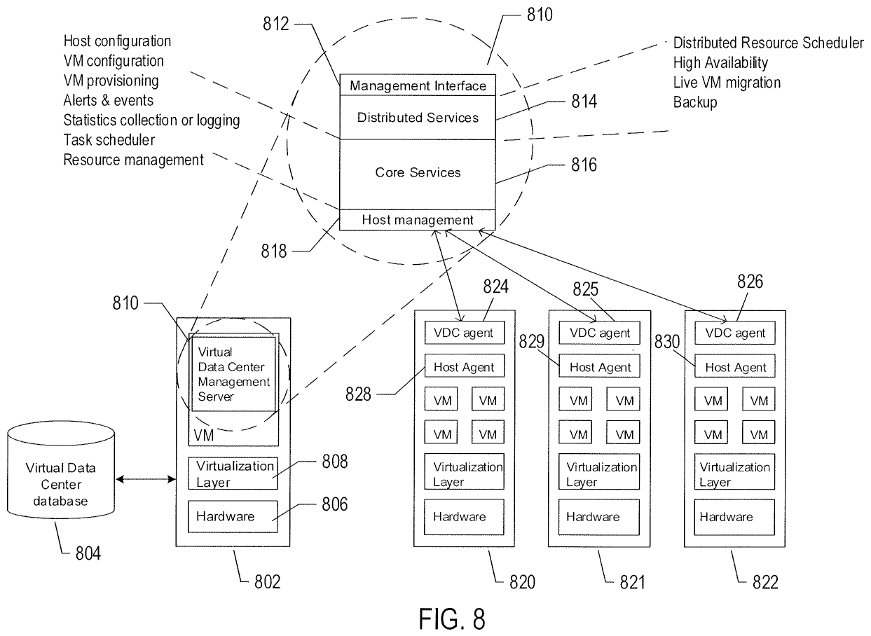

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

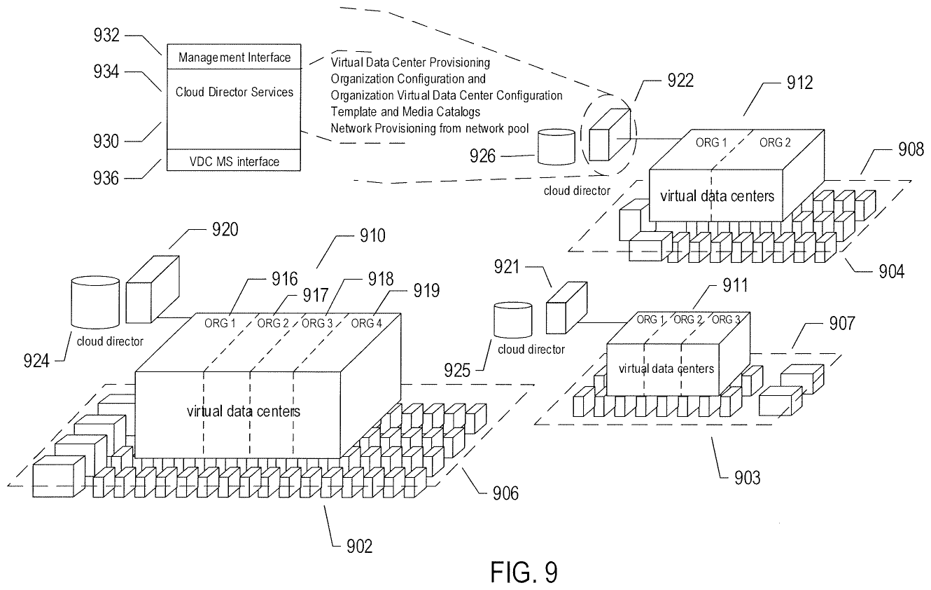

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

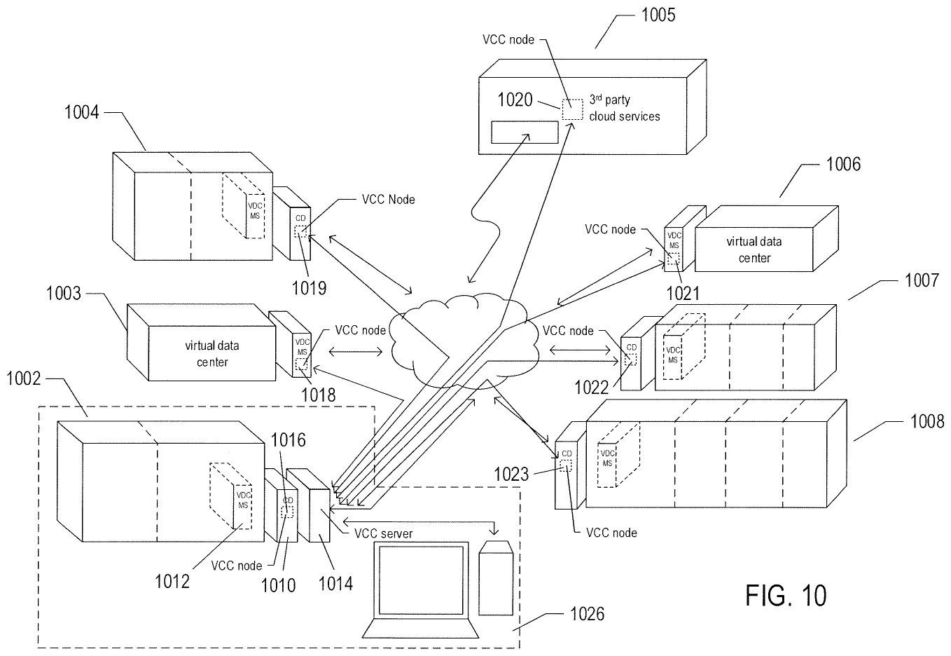

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system for use by containers. A container is a software package that uses virtual isolation to deploy and run one or more applications that access a shared operating system kernel. Containers isolate components of the host used to run the one or more applications. The components include files, environment variables, dependencies, and libraries. The host OS constrains container access to physical resources, such as CPU, memory and data storage, preventing a single container from using all of a host's physical resources. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

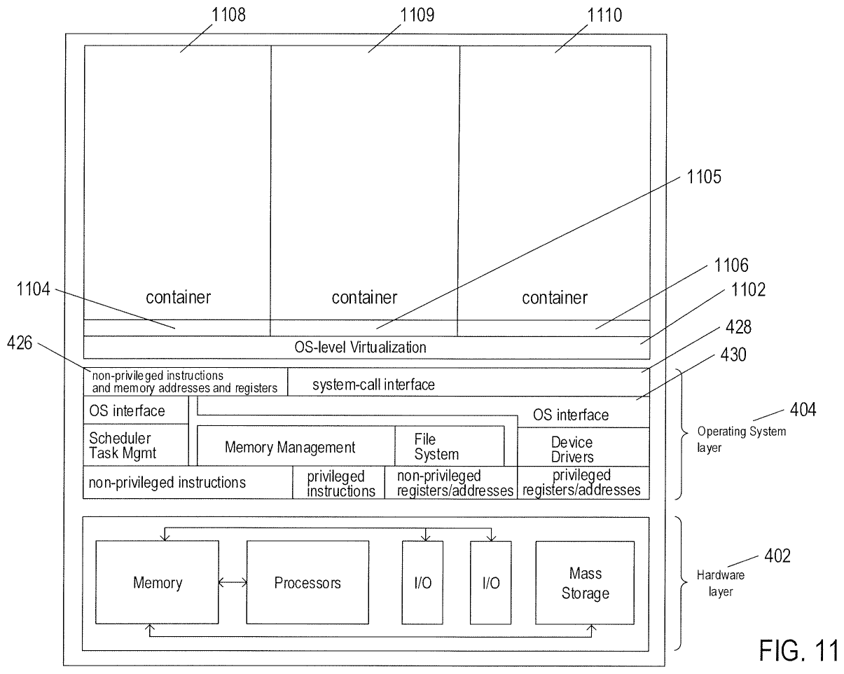

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

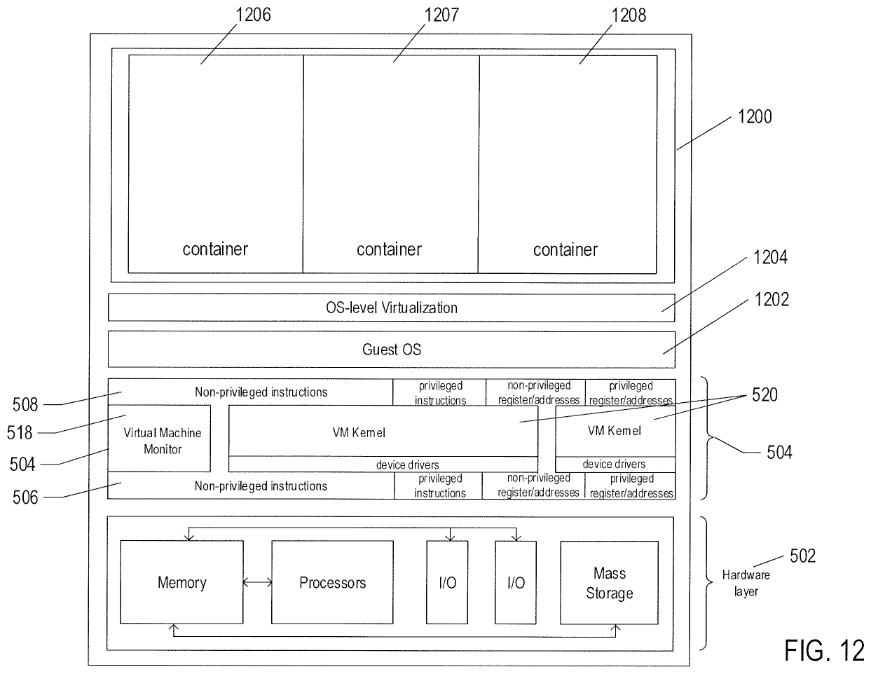

FIG. 12 shows an approach to implementing the containers on a VM. FIG. 12 shows a host computer similar to the host computer shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Processes and Systems for Determining the State of a Complex Computational System of a Distributed Computing System

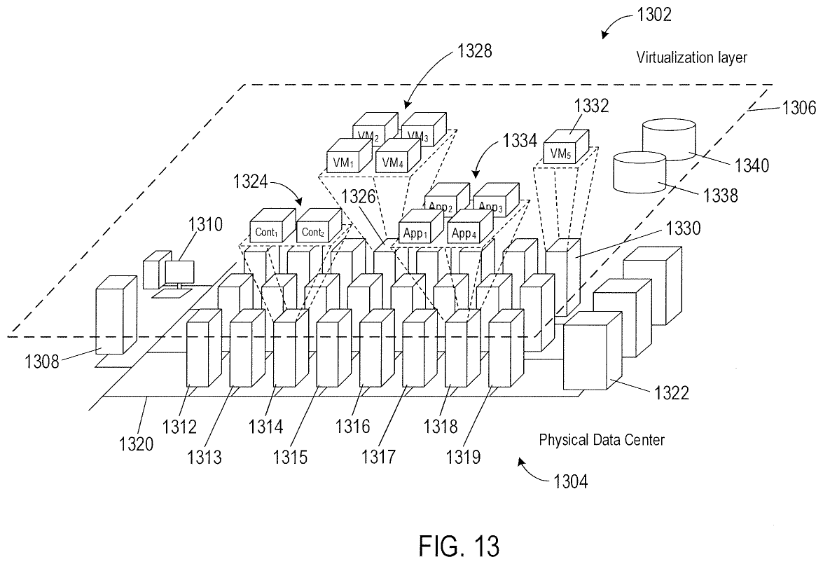

FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including a management server computer 1308, any of various computers, such as PC 1310, on which a virtual-data-center (“VDC”) management interface may be displayed to system administrators and other users, server computers, such as server computers 1312-1319, data-storage devices, and network devices. The server computers may be networked together to form networks within the data center 1904. The example physical data center 1304 includes three networks that each directly interconnects a bank of eight server computers and a mass-storage array. For example, network 1320 interconnects server computers 1312-1319 and a mass-storage array 1322. Different physical data centers may include many different types of computers, networks, data-storage systems and devices connected according to many different types of connection topologies. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and network interface cards formed from the physical switches, routers, and network interface cards of the physical data center 1304. Certain server computers host VMs and containers as described above. For example, server computer 1314 hosts two containers 1324, server computer 1326 hosts four VMs 1328, and server computer 1330 hosts a VM 1332. Other server computers may host applications as described above with reference to FIG. 4. For example, server computer 1318 hosts four applications 1334. The virtual-interface plane 1306 abstracts the resources of the physical data center 1304 to one or more VDCs comprising the virtual objects and one or more virtual data stores, such as virtual data stores 1338 and 1340. For example, one VDC may comprise VMs 1328 and virtual data store 1338.

In the following discussion, the term “object” refers to a physical object or a virtual object for which metric data can be collected to detect abnormal or normal behavior of a complex computational system. A physical object may be a server computer, network device, a workstation, a PC or any other physical object of a distributed computed system. A virtual object may be an application, a VM, a virtual network device, a container, or any other virtual object of a distributed computing system. The term “resource” refers to a physical resource of a distributed computing system, such as, but are not limited to, a processor, a core, memory, a network connection, network interface, data-storage device, a mass-storage device, a switch, a router, and other any other component of the physical data center 1304. Resources of a server computer and clusters of server computers may form a resource pool for creating virtual resources of a virtual infrastructure used to run virtual objects. The term “resource” may also refer to a virtual resource, which may have been formed from physical resources used by a virtual object. For example, a resource may be a virtual processor formed from one or more cores of a multicore processor, virtual memory formed from a portion of physical memory, virtual storage formed from a sector or image of a hard disk drive, a virtual switch, and a virtual router. A “complex computational system” is a set of physical and/or virtual objects. A complex computational system may comprise the distributed computing system itself, such a data center, or any subset of physical and/or virtual objects of a distributed computing system. For example, a complex computational system may be a single server computer, a cluster of server computers, or a network of server computers. A complex computational system may be a set of VMs, containers, applications, or a VDC of a tenant. A complex computational system may be a set of physical objects and the virtual objects hosted by the physical objects.

Automated processes and systems described herein are implemented in a monitoring server that monitors complex computational systems of a distributed computing system by collecting numerous streams of time-dependent metric data associated with numerous physical and virtual resources. Each stream of metric data is time series data generated by a metric source. The metric source may be an operating system of an object, an object, or the resource. A stream of metric data associated with a resource comprises a sequence of time-ordered metric values that are recorded at spaced points in time called “time stamps.” A stream of metric data is simply called a “metric” and is denoted by

v=(xᵢ)ᵢ₌₁^{N}^{ᵥ}=(x(tᵢ))ᵢ₌₁^{N}^{ᵥ} (1)
where
   Nᵥ is the number of metric values in the sequence;
   xᵢ=x(tᵢ) is a metric value;
   tᵢ is a time stamp indicating when the metric value was recorded in a data-storage device; and
   subscript i is a time stamp index i=1, . . . , Nᵥ.

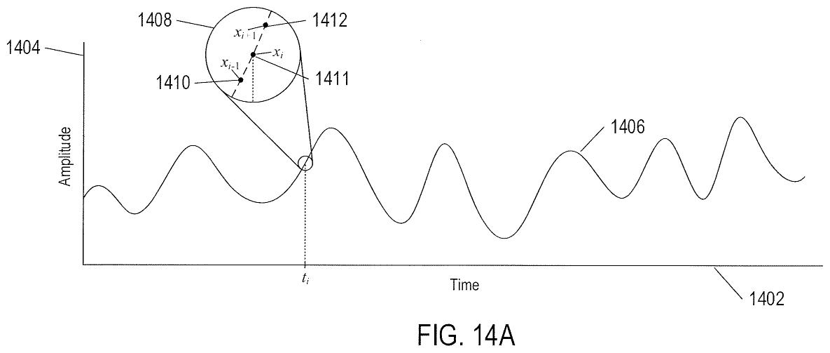

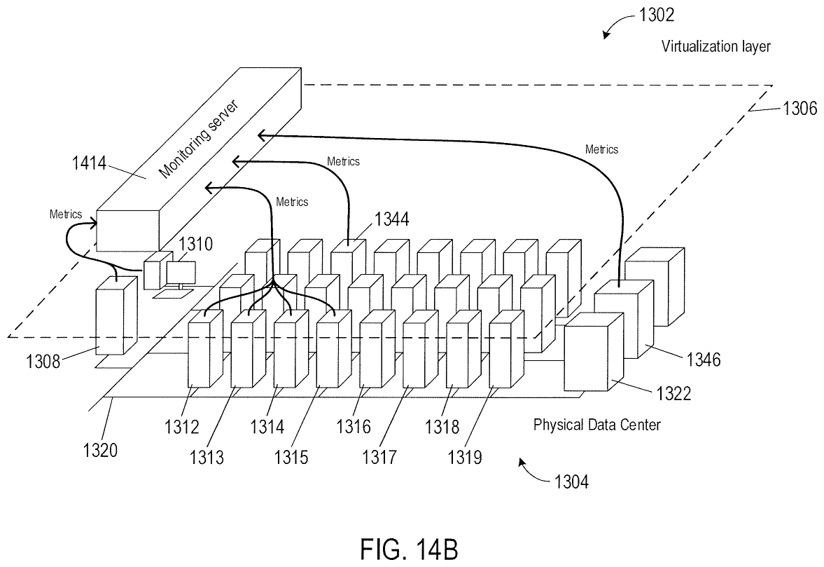

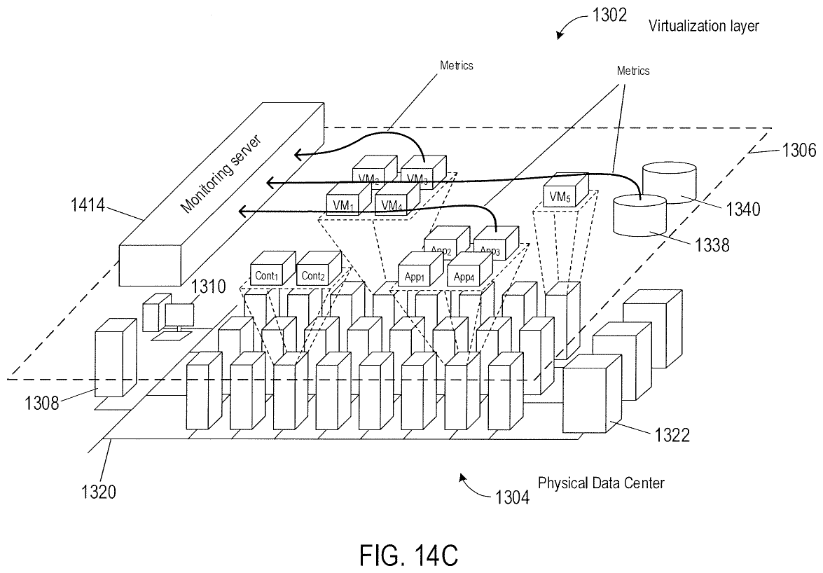

FIG. 14A shows a plot of an example metric associated with a resource. Horizontal axis 1402 represents time. Vertical axis 1404 represents a range of metric value amplitudes. Curve 1406 represents a metric as time series data. In practice, a metric comprises a sequence of discrete metric values in which each metric value is recorded in a data-storage device. FIG. 14 includes a magnified view 1408 of three consecutive metric values represented by points. Each point represents an amplitude of the metric at a corresponding time stamp. For example, points 1410-1412 represent three consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory a VM uses over time. The metric may represent network throughput for a server computer. Network throughput is the number of bits of data transmitted to and from a physical or virtual object and is recorded in megabits, kilobits, or bits per second. The metric may represent network traffic for a server computer. Network traffic at a physical or virtual object is a count of the number of data packets received and sent per unit of time.

In FIGS. 14B-14C, a monitoring server 1414 collects numerous metrics associated with numerous physical and virtual resources. The monitoring server 1414 may be implemented in one or more VMs to collect and process the metrics as described below. As shown in FIGS. 14B-14C, directional arrows represent metrics sent from physical and virtual resources to the monitoring server 1414. In FIG. 14B, PC 1310, server computers 1308 and 1312-1315, and mass-storage array 1346 send metrics to the monitoring server 1414. Clusters of server computers may also send metrics to the monitoring server 1414. For example, a cluster of server computers 1312-1315 sends metrics to the monitoring server 1414. In FIG. 14C, the operating systems, VMs, containers, applications, and virtual storage may independently send metrics to the monitoring server 1414, depending on when the metrics are generated. For example, certain objects may send time series data of a metric as the data is generated while other objects may only send time series data of a metric at certain times or in response to a request from the monitoring server 1414.

A complex computational system comprising physical and/or virtual objects may have tens, hundreds, thousands or millions of associated metrics that are sent to a monitoring server, such as the monitoring server 1414. For example, a server computer alone may have hundreds of metrics that represent usage of each core of a multicore core processor, memory usage, storage usage, network throughput, error rates, datastores, disk usage, average response times, peak response times, thread counts, and power usage, just to name a few. A single virtual object, such as a VM, may have hundreds of associated metrics that monitor both physical and virtual resource usage, such as virtual CPU usage, virtual memory usage, virtual disk usage, virtual storage space, number of data stores, average and peak response times for various physical and virtual resources of the VM, network throughput, and power usage, just to name a few. The metrics collected and recorded by the monitoring server 1414 contain information that may be used to determine the state of a complex computational system. For example, the term “state” may refer to the normal or abnormal behavior of a complex computational system. The term “state” may refer to the workload of a complex computational system. For example, the workload of a complex computational system may be low, medium, or high. The term “state” may refer to risk of danger or abnormal behavior of a complex computational system. For example, if the state of a complex computational system indicates the risk from the of abnormal behavior is low, a warning message may be generated; if the state of a complex computational system indicates the risk from the of abnormal behavior is medium, an error message may be generated; or if the state of a complex computational system indicates the risk from the of abnormal behavior is critical, a critical message may be generated.

Processes and systems may execute remedial measures depending on the state of the complex computational system. For example, if the state of the complex computational system is normal or low, the state of the complex computational system may continue to be monitored. On the other hand, if the state of the complex computational system is abnormal, such as when the workload reaches a medium or high level, or the risk from abnormal behavior is medium or high, remedial measures may be triggered. The remedial measures may include generating recommendations to correct the abnormal or potential abnormal state of the complex computational system or the remedial measures may include automatically executing steps to correct the abnormal state, such as reconfiguring a virtual network of a VDC or migrating VMs, containers, or applications from one server computer to another. For example, remedial measures may include, but are not limited to, powering down server computers, replacing VMs disabled by physical hardware problems and failures, spinning up cloned VMs on additional server computers to ensure that the services provided by the VMs are accessible to increasing demand for services.

Processes and systems identify metrics associated with a complex computational system. The metrics associated with a complex computational system are denoted in set notation by:

{vⱼ}ⱼ₌₁^{J}={(xᵢ^{(j)})ᵢ₌₁^{N}^{_{v,j}}}ⱼ₌₁^{J}={(x^{(j)}(tᵢ))ᵢ₌₁^{N}^{_{v,j}}}ⱼ₌₁^{J} (2)
where
   j is a metric index for the complex computational system j=1, . . . , J;
   N_{v,j} is the number of the metric values in the j-th metric; and
   J is an integer number of metrics.

Processes and systems prepare the metrics by deleting constant and nearly constant metrics, which are not useful in identifying abnormal performance of a complex computational system. Constant or nearly constant metrics may be identified by the magnitude of the standard deviation of each metric over time. The standard deviation is a measure of the amount of variation or degree of variability associated with a metric. A large standard deviation indicates large variability in the metric. A small standard deviation indicates low variability in the metric. The standard deviation is compared to a variability threshold to determine whether the metric has acceptable variation for identification of the state of the complex computational system.

The standard deviation of a metric may be computed by:

$${σ}_{j} = \sqrt{\frac{1}{{N}_{v , j}} {\sum }_{i = 1}^{{N}_{v , j}} {( {x}_{i}^{( j )} - {μ}_{j} )}^{2}} \qquad ( 3 a )$$

where the mean of the metric is given by

$${μ}_{j} = \frac{1}{{N}_{v , j}} {\sum }_{i = 1}^{{N}_{v , j}} {x}_{i}^{( j )} \qquad ( 3 b )$$

When the standard deviation σⱼ>εₛₜ, where εₛₜ is a variability threshold (e.g., εₛₜ=0.01), the metric vⱼ is non-constant and is retained. Otherwise, when the standard deviation σⱼ≤εₛₜ, the metric vⱼ is constant and is omitted from determining the state of the complex computational system. Let M be the number of non-constant metrics (i.e., σⱼ>εₛₜ), where M≤J.

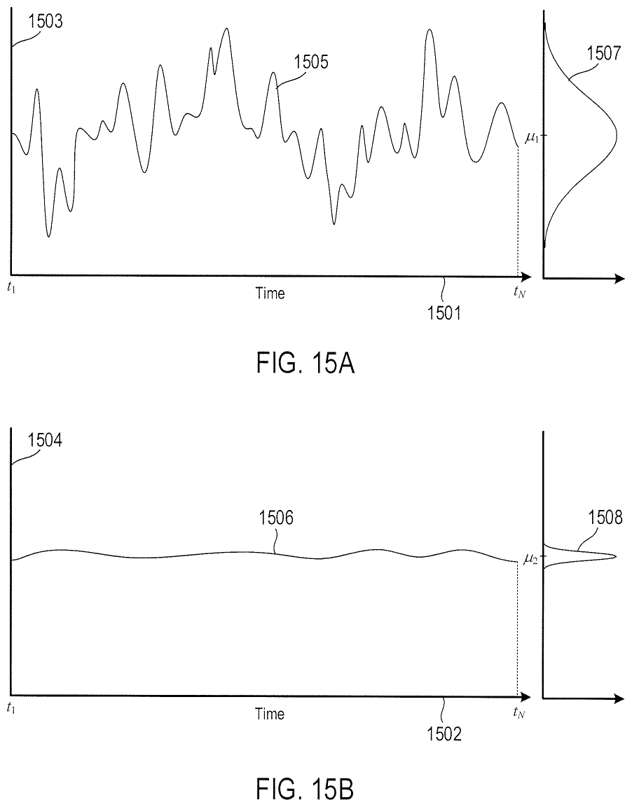

FIGS. 15A-15B show plots of example non-constant and constant metrics over time. Horizontal axes 1501 and 1502 represent time. Vertical axis 1503 represents a range of metric values for a first metric v₁. Vertical axis 1504 represents the same range of metric values for a second metric v₂. Curve 1505 represents the metric v₁ over a time interval between time stamps t₁ and t_{N}. Curve 1506 represents the metric v₂ over the same time interval. FIG. 15A includes a plot an example first distribution 1507 of the first metric centered about a mean value μ₁. FIG. 15B includes a plot an example second distribution 1508 of the second metric centered about a mean value μ₂. The distributions 1507 and 1508 reveal that the first metric 1505 has a much higher degree of variability than the second metric, which is nearly constant over the time interval.

The metrics associated with a complex computational system are typically not synchronized. For example, metric values may be recorded at periodic intervals, but the periodic intervals between time stamps may be different. On the other hand, metric values may be recorded at nonperiodic intervals and are not synchronized with the time stamps of other metrics. In certain cases, the monitoring server 1414 may request metric data from metric sources at regular intervals while in other cases, the metric sources may actively send metric data at periodic intervals or whenever metric data becomes available.

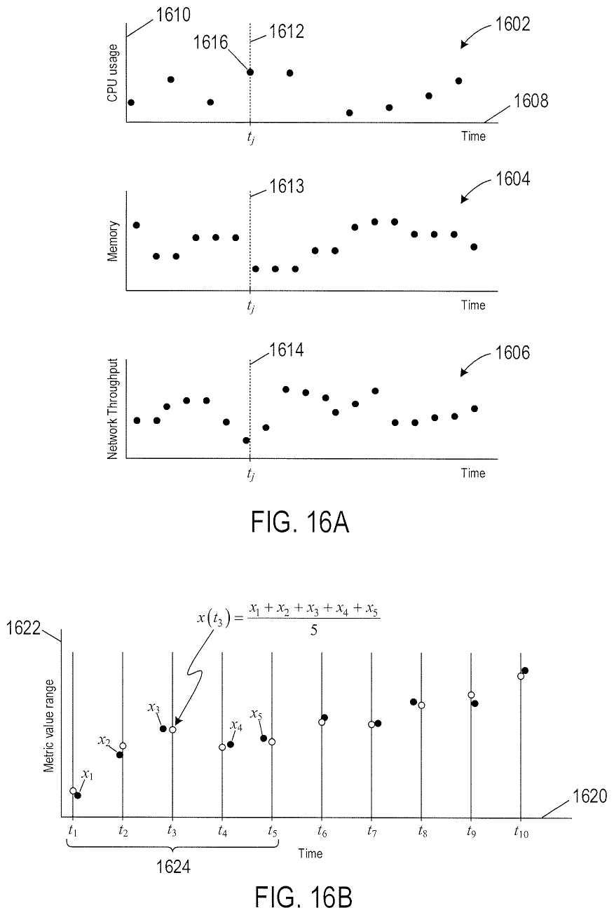

FIG. 16A shows plots of three examples of unsynchronized metrics for CPU usage 1602, memory 1603, and network throughput 1606 recorded in the same time interval. Horizontal axes, such as horizontal axis 1608, represent the length of the time interval. Vertical axes, such as vertical axis 1610, represent ranges of metric values for the CPU, memory, and network throughput. Dots represent metric values recorded at different time stamps in the time interval. CPU metric values are recorded at different periodic intervals than the memory and network throughput metric values. Dashed lines 1612-1614 mark the same time stamp, tⱼ, in the time interval. A metric value 1616 represents CPU usage for the object recorded at time stamp tⱼ. However, the memory and network throughput metrics do not have metric values recorded at the same time stamp tⱼ. As a result, the CPU usage, memory, and network throughput are not synchronized.

For the types of processing carried out by the currently disclosed processes and systems, it is convenient to ensure that the metric values for metrics used to determine the state of a complex computational system are logically emitted in a periodic manner and that the transmission of metric data is synchronized among the metrics to a general set of uniformly spaced time stamps. Metric values may be synchronized by computing a run-time average of metric values in a sliding time window centered at each time stamp of the general set of uniformly spaced time stamps. In an alternative implementation, the metric values with time stamps in the sliding time window may be smoothed by computing a running time median of metric values in the sliding time window centered at a time stamp of the general set of uniformly spaced time stamps. Processes and systems may also synchronize the metrics by deleting time stamps of missing metric values and/or interpolating missing metric data at time stamps of the general set of uniformly spaced time stamps using linear, quadratic, or spline interpolation.

FIG. 16B shows a plot of metric values synchronized to a general set of uniformly spaced time stamps. Horizontal axis 1620 represents time. Vertical axis 1622 represents a range of metric values. Solid dots represent metric values recorded at irregularly spaced time stamps. Marks located along time axis 1620 represent time stamps of a general set of uniformly spaced time stamps. Note that the metric values are not aligned with the time stamps of the general set of uniformly spaced time stamps. Open dots represent metric values aligned with the time stamps of the general set of uniformly spaced time stamps. Bracket 1624 represents a sliding time window centered at a time stamp t₃ or the general set. The metric values x₁, x₂, x₃, x₄, and x₅ have time stamps within the sliding time window 1624 and are averaged 1632 to obtain synchronized metric value 1634 at the time stamp t₃ of the general set of uniformly spaced time stamps.

The resulting M synchronized and non-constant metrics are represented in set notation by

{uⱼ}ⱼ₌₁^{M}={(xᵢ^{(j)})ᵢ₌₁^{N}}ⱼ₌₁^{M}{(x^{(j)}(tᵢ))ᵢ₌₁^{N}}ⱼ₌₁^{M} (4)
where N is the number of metric values in each of the M synchronized and non-constant metrics.

### Detecting Outliers of Each Metric of a Complex Computational System

Processes and systems use the M synchronized and non-constant) metrics (i.e., {uⱼ}ⱼ₌₁^{M}) to determine the state of the complex computational system over the time interval [t₁, t_{N}]. In other words, the time interval [t₁, t_{N}] is a historical time window for identifying previous states of the complex computational system. Processes and systems determine normal and outlier metric values of each metric of the complex computational system over the historical time window using any of various different techniques.

Certain metrics of a complex computational system may have an increasing or decreasing trend over time, while others may exhibit seasonality, and still others may exhibit no trend or seasonality. For example, each metric data value of a metric may be decomposed as follows:

xᵢ^{(j)}=Tᵢ^{(j)}+Aᵢ^{(j)}+Sᵢ^{(j)} (5)
where
   i=1, . . . , N;
   Tᵢ^{(j)} is the trend component;
   Aᵢ^{(j)} is the stochastic component; and
   Sᵢ^{(j)} is the seasonal or periodic component.
      Note that certain metrics may be non-trendy and non-seasonal (e.g., Aᵢ^{(j)}≠0 and Tᵢ^{(j)}=Sᵢ^{(j)}=0, for all i). Other metrics may have two components (e.g., Aᵢ≠0, Sᵢ≠0, and Tᵢ=0 or Aᵢ≠0, Sᵢ=0, and Tᵢ≠0, for all i). And still other metrics may have all three components.

Processes and systems compute a trend estimate for each metric in the historical time window. If a trend estimate does not adequately fit a corresponding metric over the historical time window, the metric is non-trendy. On the other hand, if a trend estimate fits the corresponding metric, the trend estimate is subtracted from the metric to obtain a detrended metric over the historical time window.

A linear trend estimate may be determined over the historical time window by a linear equation given by:

Tᵢ=α+βtᵢ (6a)
where
   α is vertical axis intercept of the estimated trend; and
   β is the slope of the estimated trend.

The slope α and vertical axis intercept β of Equation (6a) may be determined by minimizing a weighted least squares equation given by:

$$L = {\sum }_{i = 1}^{N} {{w}_{i} ( {x}_{i}^{( j )} - α - β {t}_{i} )}^{2} \qquad ( 6 b )$$

where wᵢ is a normalized weight function.
   Normalized weight functions wᵢ weight recent metric data values higher than older metric data values within the historical interval. Examples of normalized weight functions that give more weight to more recently received metric data values within the historical interval include wᵢ=e^{(i-N)} and wᵢ=i/N, for i=1, . . . , N. The slope parameter of Equation (6a) is computed as follows:

$$β = \frac{{Σ}_{i = 1}^{N} {w}_{i} ( {t}_{i} - {t}_{w} ) ( {x}_{i}^{( j )} - {x}_{w}^{( j )} )}{{Σ}_{i = 1}^{N} {{w}_{i} ( {t}_{i} - {t}_{w} )}^{2}} \qquad ( 6 c )$$

where

$${t}_{w} = \frac{{Σ}_{i = 1}^{N} {w}_{i} {t}_{i}}{{Σ}_{i = 1}^{n} {w}_{i}} \\ {z}_{w} = \frac{{Σ}_{i = 1}^{N} {w}_{i} {x}_{i}^{( j )}}{{Σ}_{i = 1}^{N} {w}_{i}}$$

The vertical axis intercept parameter of Equation (6a) is computed as follows:

α=z_{w}−βt_{w} (6d)

In other implementations, the weight function may be defined as wᵢ≡1.

A goodness-of-fit parameter is computed as a measure of how well the trend estimate fits the metric values in the historical interval:

$${R}^{2} = \frac{{\sum }_{i = 1}^{N} {( {T}_{i} - {x}_{w}^{( j )} )}^{2}}{{\sum }_{i = 1}^{N} {( {x}_{i}^{( j )} - {x}_{w}^{( j )} )}^{2}} \qquad ( 7 )$$

The goodness-of-fit R² ranges between 0 and 1. The closer R² is to 1, the closer linear Equation (6a) is to providing an accurately estimate of a linear trend in the metric data of the historical interval. When R²≤Th_{trend}, where Th_{trend} is a user defined trend threshold less than 1, the estimated trend of Equation (6a) is not a good fit to the sequence of metric data values and the metric in the historical interval is regarded as non-trendy. On the other hand, when R²>Th_{trend}, the estimated trend of Equation (6a) is recognized as a good fit to the sequence of metric data in the historical interval and the trend estimate is subtracted from the metric data values.

For metrics that contain a seasonal component, processes and systems may use techniques described in “STL: A Seasonal-Trend Decomposition Procedure Based on Loess,” by R. B. Cleveland et al., Journal of Official Statistics, Vol. 6, No. 1, pp. 3-73, 1990 to determine the seasonal component. Each metric that contains a seasonal component is seasonally adjusted by subtracting the seasonal component.

For each time stamp index i=1, . . . , N, the trend estimate and/or the seasonal component are subtracted from each metric value in the historical time window to obtain detrended and seasonally adjusted metric values given by:

\hat{x}ᵢ^{(j)}=xᵢ^{(j)}−Tᵢ−Sᵢ (8)

The detrended and seasonally adjusted metric values form a detrended and seasonally adjusted metric denoted by (\hat{x}ᵢ^{(j)})ᵢ₌₁^{N}.

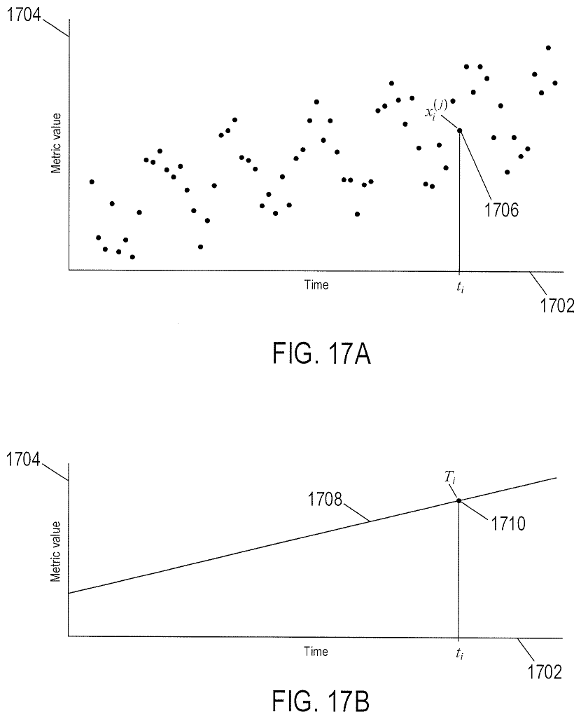

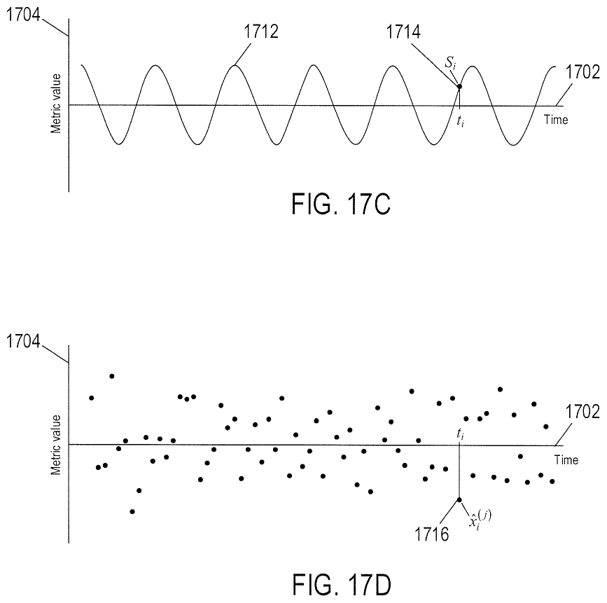

FIGS. 17A-17D show an example of obtaining a detrended and seasonally adjusted metric. In FIGS. 17A-17D, horizontal axis 1702 represent a historical time window. Vertical axis 1704 represents a range of metric values. In FIG. 17A, points, such as point 1706, represent metric values of a metric. FIG. 17A reveals that the metric values vary over time, but the metric includes an increasing trend and a seasonal component. In FIG. 17B, line 1708 represents a trend estimate of the metric determined according to Equations (6a)-(6d). Points along the trend estimate 1708 at corresponding time stamps of the metric are estimates of the trend component. For example, the trend estimate, Tᵢ, at point 1710 is an estimate of the trend component of the metric value xᵢ^{(j)} 1706 of FIG. 17A. In FIG. 17C, periodic curve 1712 represents seasonality of the metric determined according to the techniques described in “STL: A Seasonal-Trend Decomposition Procedure Based on Loess.” Points along the seasonal curve 1712 that correspond to time stamps of the metric are estimates of the seasonality contained in the metric values. For example, seasonal component, Sᵢ, at point 1714 is an estimate of the seasonality contribution to the metric value xᵢ^{(j)} 1706 of FIG. 17A. FIG. 17D shows a plot of detrended and seasonally adjusted metric values. Each detrended and seasonally adjusted metric value is obtained by subtracting a corresponding trend estimate of the trend in FIG. 17B and a corresponding seasonal component in FIG. 17C from the metric value in FIG. 17A. For example, point 1716 is a detrended and seasonally adjusted metric value obtained as described above with reference to Equation (8).

For the sake of convenience, in the following discussion, the tell “metric” refers to a detrended and/or seasonally adjusted metric and refers to a non-trendy and non-seasonal metric. The term “metric value” refers to a metric value that does not have a trend and/or seasonal component and refers to a detrended and seasonally adjusted metric value. Likewise, the notation for a metric value, xᵢ^{(j)}, is used to represent a non-trendy and non-seasonal metric value, xᵢ^{(j)}, and a detrended and seasonally adjusted metric value \hat{x}ᵢ^{(j)}.

Processes and systems may use any of various different techniques to determine upper and lower bounds for identify outlier and normal metric values for each of the metrics of a complex computational system. Outlier metric values may be an indication of abnounal behavior of the complex computational system at corresponding time stamps. Normal metric values indicate normal behavior or performance of the complex computational system at corresponding time stamps.

In one implementation, if the metric values of a metric are normally distributed over the historical time window, normal distribution parameters may be used to separately determine upper and lower bounds for each metric. A metric value is normal if the following condition is satisfied:

μⱼ−Zσⱼ≤xᵢ^{(j)}≤μⱼ+Zσⱼ (9)
where
   Z is the number of standard deviations;

$${μ}_{j} = \frac{1}{N} {\sum }_{i = 1}^{N} {x}_{i}^{( j )}$$

$${σ}_{j} = \sqrt{\frac{1}{N} {\sum }_{i = 1}^{N} {( {x}_{i}^{( j )} - {μ}_{j} )}^{2}}$$

μⱼ+Zσⱼ is an upper bound; and
μⱼ−Zσⱼ is a lower bound.
   Otherwise, if a metric value does not satisfy the condition given by Equation (9) (i.e., violates the upper or lower bound), the metric value is located outside the upper or lower normal bound and is identified as an outlier.

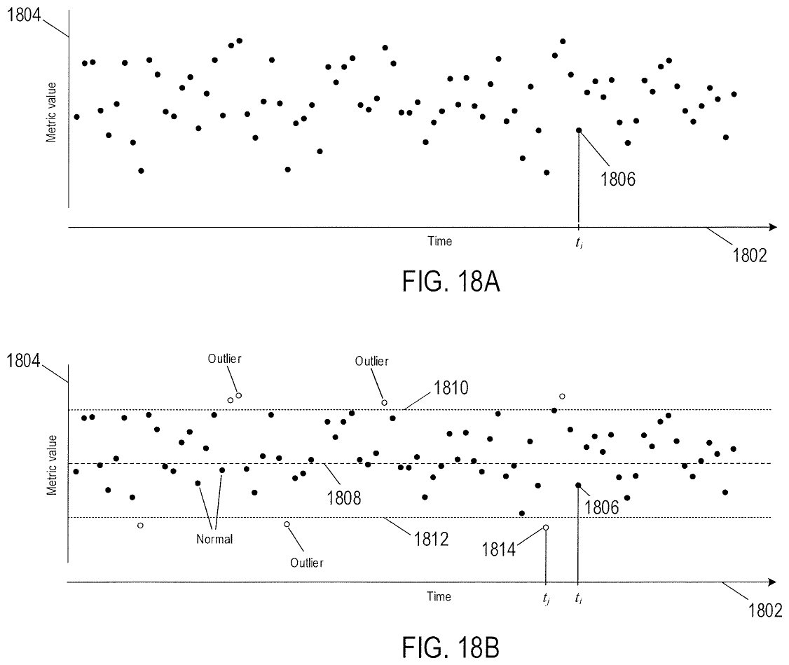

FIG. 18A shows a plot of an example metric with normally distributed metric values over a historical time window. Horizontal axis 1802 represents a historical time window. Vertical axis 1804 represents a range of metric values. Each point represents a metric value of the metric at a time stamp. For example, point 1806 represents a metric value xᵢ^{(j)} of the j-th metric at the time stamp tᵢ. FIG. 18B shows normal and outlier metric values for the example metric in FIG. 18A. Dashed line 1808 represents the average μⱼ of the metric values for the j-th metric over the historical time window. Dotted line 1810 represents an upper bound μⱼ+Zσⱼ. Dotted line 1812 represents a lower bound μⱼ−Zσⱼ. Metric values that are greater than the upper bound 1810 or are less than the lower bound 1812 are identified as outlier metric values, as represented by open dots. For example, open dots, such as open dot 1814, are identified as outlier metric values. Metric values that are located between the upper bound 1810 and the lower bound 1812 are identified as normal metric values, such as metric value 1806.

In another implementation, a statistical dispersion technique, such a whisker's technique, may be used to separately determine upper and lower bounds for each metric. For example, metric values located outside an interval (q_{0.25}−Qiqr, q_{0.75}+Qiqr), where q_{0.25} is the first quartile, q_{0.75} is the third quartile, iqr is the interquartile range, and Q is a number (e.g., Q=1.5 or 2). The quantity q_{0.25}−Qiqr serves as a lower bound, and the quantity q_{0.75}+Qiqr serves as an upper bound. A metric value is normal if the following condition is satisfied:

q_{0.25}−Qiqr≤xᵢ^{(j)}≤q_{0.75}+Qiqr (10)

Otherwise, if a metric value does not satisfy the condition given by Equation (10) (i.e., violates the upper or lower bounds), the metric value is located outside the interval and is identified as an outlier.

In another implementation, time series forecasting techniques are performed using a time-series model to construct upper and lower confidence intervals for a metric. The time-series models include an autoregressive (“AR”) model, an autoregressive moving average model (“ARMA”) model, or an autoregressive integrated moving average model (“ARIMA”). Metric values located outside the upper and lower confidence bounds are identified as outliers. Metric values located within the confidence intervals are identified as normal metric values. A stationary metric comprises metric values that vary over time in a stable manner about a fixed mean, such as the metric shown in FIG. 18. On the other hand, the mean of a non-stationary system indicator is not fixed and varies over time. Whether or not the metric is stationary or non-stationary determines which time-series model is used. The historical time window [t₁, t_{N}] is partitioned into a historical interval [t₁, t_{K}] and a forecast interval (t_{K}, t_{N}], where K<N. Time series forecasting techniques compute forecast metric values in the forecast interval based on metric values in the historical interval.

The ARMA model may be applied to a stationary system indicator to forecast metric values over a forecast interval. The ARMA model is represented, in general, by

ϕ(B)xₖ^{(j)}=θ(B)aₖ (11a)
where
   B is a backward shift operator;

$$φ ( B ) = 1 - {\sum }_{i = 1}^{p} {φ}_{i} {B}^{i}$$

$$θ ( B ) = 1 - {\sum }_{i = 1}^{q} {θ}_{i} {B}^{i}$$

aₖ is white noise;
ϕᵢ is an i-th autoregressive weight parameter;
θᵢ is an i-th moving-average weight parameter;
p is the number of autoregressive terms called the “autoregressive order;” and
q is the number of moving-average terms called the “moving-average order.”
   The white noise is aₖ is a sequence of independent and identically distributed random variables with mean zero and variance σₐ². The backward shift operator is defined as Bxₖ^{(j)}=xₖ₌₁^{(j)} and Bⁱxₖ^{(j)}=xₖ₌ᵢ^{(j)}. In expanded notation, the ARMA model of Equation (11a) is represented by

$${x}_{k}^{( j )} = {\sum }_{i = 1}^{p} {φ}_{i} {x}_{k - i}^{( j )} + {a}_{k} + {μ}_{z} Φ + {\sum }_{i = 1}^{q} {θ}_{i} {a}_{k - i} \qquad ( 11 b )$$

where Φ=1−ϕ₁− . . . −ϕₚ.
   The white noise parameters aₖ may be determined at each time stamp by randomly selecting a value from a fixed normal distribution with mean zero and non-zero variance. The autoregressive weight parameters are computed from the matrix equation:

[symbol]

= [symbol] (12)
where

$$\vec{φ} = [ \begin{matrix}{φ}_{1} \\ ⋮ \\ {φ}_{p}\end{matrix} ] ;$$

$$\vec{ρ} = [ \begin{matrix}{ρ}_{1} \\ ⋮ \\ {ρ}_{p}\end{matrix} ] ; and$$

$${P}^{- 1} = {[ \begin{matrix}1 & {ρ}_{1} & … & {ρ}_{p - 1} \\ {ρ}_{1} & 1 & … & {ρ}_{p - 2} \\ ⋮ & ⋮ & ⋱ & ⋮ \\ {ρ}_{p - 1} & {ρ}_{p - 2} & … & 1\end{matrix} ]}^{- 1}$$

The matrix elements are computed from the autocorrelation function given by:

$${ρ}_{k} = \frac{{γ}_{k}}{{γ}_{0}} \\ where \\ {γ}_{k} = \frac{1}{K} {\sum }_{i = 1}^{K - k} ( {x}_{i}^{( j )} - {μ}_{z} ) ( {x}_{k + i}^{( j )} - {μ}_{K} ) \\ {γ}_{0} = \frac{1}{K} {\sum }_{i = 1}^{K} {( {x}_{i}^{( j )} - {μ}_{K} )}^{2} \\ {μ}_{K} = \frac{1}{K} {\sum }_{i = 1}^{K} {x}_{i}^{( j )} \qquad ( 13 )$$

The moving-average weight parameters, θᵢ, may be computed using a gradient descent technique.

The ARMA model may be used to compute forecast metric values in a forecast interval as:

$${\tilde{x}}_{K + l}^{( j )} = {\sum }_{i = 1}^{l - 1} {φ}_{i} {\tilde{x}}_{K + l - i}^{( j )} + {\sum }_{i = l}^{p} {φ}_{i} {x}_{K + l - 1}^{( j )} + {a}_{K + l} + {μ}_{K} Φ + {\sum }_{i = 1}^{q} {θ}_{i} {a}_{K + l - i} \qquad ( 14 )$$

where
   i=1, . . . , L is a lead time index with L the number of lead time stamps in the forecast interval;
   “˜” denotes a forecast metric value;
   \hat{x}_{K}^{(j)} is zero; and
   a_{K+1} is the white noise for the lead time stamp t_{K+l}.

In other implementations, forecast metric values may be computing using an autoregressive process (“AR”) model given by:

$${x}_{k}^{( j )} = {\sum }_{i = 1}^{p} {φ}_{i} {x}_{k - i}^{( j )} + {a}_{K} + {μ}_{K} Φ \qquad ( 15 )$$

The AR model is obtained by omitting the moving-average weight parameters from the ARMA model. By omitting the moving-average model, computation of the autoregressive weight parameters of the autoregressive model is less computationally expensive than forecasting metric values with the ARMA models.

For a non-stationary metric, an ARIMA model may be used to compute forecast metric values in the forecast interval. The ARIMA model is given by:

ϕ(B)∇^{d}xₖ^{(j)}=θ(B)aₖ (16)
where ∇^{d}=(1−B)^{d}.
   The ARIMA autoregressive weight parameters and move-average weight parameters are computed in the same manner as the parameters of the ARMA models described above in Equation (11a).

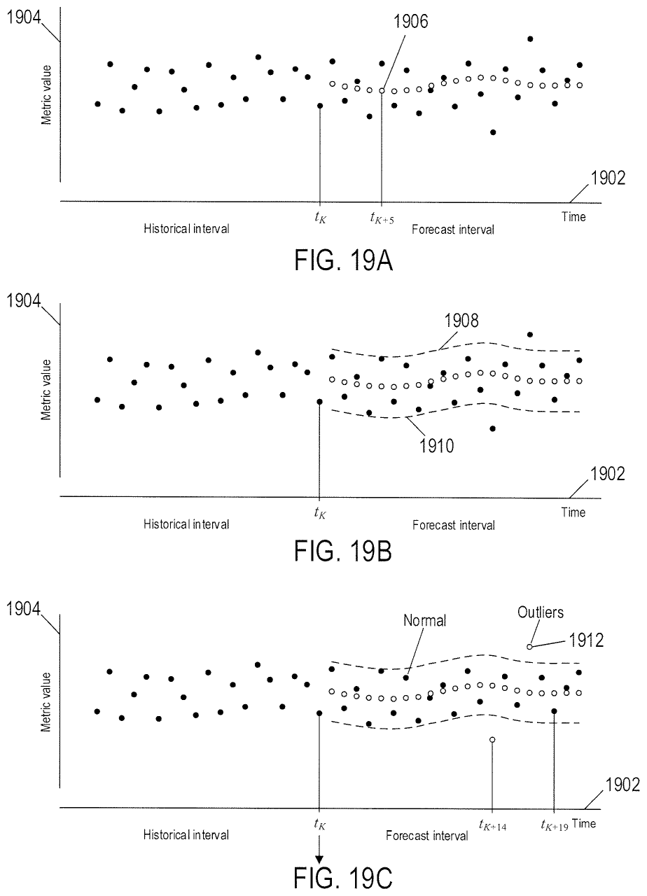

FIG. 19A shows a plot of an example metric and forecast metric values. Horizontal axis 1902 represents time. Vertical axis 1904 represents a range of metric values. The time axis 1902 represents the historical time window divided into a historical interval and a forecast interval at a time stamp t_{K}. Metric values with time stamps less than or equal to the time stamp t_{K} are used to compute forecast metric values, using an AR, ARMA, or an ARIMA as described above, at time stamps greater than t_{K}. Lighter shaded points represent forecast metric values. For example, lighter shaded point 1906 x_{K+5}^{(j)} represents a forecast metric value at the time stamp t_{K+5}.

Upper and/or lower confidence bounds are computed for each metric associated with the complex computational system over the forecast interval and are used to identify outlier metric values in the forecast interval. The upper and/or lower confidence bounds are the upper and lower bounds for determine outlier and normal metric values. Upper confidence values of the upper confidence bound are computed at time stamps in the forecast interval by

uc_{K+l}=x_{K+l}^{(j)}+Cσ(l) (17a)

and lower confidence values of the lower confidence bound may also be computed at time stamps in the forecast interval by

lc_{K+l}=x_{K+l}^{(j)}−Cσ(l) (17b)
where
   C is a prediction interval coefficient; and
   σ(l) is an estimated standard deviation of the l-th lead time stamp in the forecast interval.

The upper and lower confidence values define a confidence interval denoted by [lc_{K+l}, uc_{K+l}]. The prediction interval coefficient C corresponds to a probability that a metric value will lie in the confidence interval [lc_{K+l}, uc_{K+l}]. Examples of prediction interval coefficients are provided in the following table:

| Coefficient (C) | Percentage (%) |
|---|---|
| 2.58 | 99 |
| 1.96 | 95 |
| 1.64 | 90 |
| 1.44 | 85 |
| 1.28 | 80 |
| 0.67 | 50 |

For example, a 95% confidence gives a confidence interval [\tilde{x}_{K+l}^{(j)}−1.96σ(l), \tilde{x}_{K+l}^{(j)}+1.96σ(l)]. In other words, there is a 95% chance that the K+l-th forecast metric value will lie within the confidence interval based on the metric values in the historical interval.

The estimated standard deviation σ(l) in Equations (17a)-(17b) is given by:

$$σ ( l ) = \sqrt{{σ}_{a}^{2} {\sum }_{j = 1}^{l - 1} {ψ}_{j}^{2}} \qquad ( 18 )$$

where the ψⱼ's are the weights.
   When forecasting is executed using an AR model, the weights of Equation (18) are computed recursively as follows:

$${ψ}_{j} = {\sum }_{i = 1}^{ρ} {φ}_{i} {ψ}_{j - i} \qquad ( 19 a )$$

where ψ₀=1.
When forecasting is executed using an ARMA model, the weights of Equation (18) are computed recursively as follows:

$${ψ}_{j} = {\sum }_{i = 1}^{p} {φ}_{i} {ψ}_{j - i} - {θ}_{j} \qquad ( 19 b )$$

where θⱼ=0 for j>q.
   When forecasting is executed using an ARIMA model, the weights of Equation (18) are computed recursively as follows:

$${ψ}_{j} = {\sum }_{i = 1}^{p + d} {φ}_{i} {ψ}_{j - i} - {θ}_{j} \qquad ( 19 c )$$

FIG. 19B shows upper and lower bounds for the forecast metric values over the forecast interval shown in FIG. 19A. Dashed curve 1908 represents an upper bound. Dashed curve 1910 represents a lower bound. FIG. 19C shows outlier metric values identified by open points, such as outlier 1912.

### Construction of a Total Outlier Metric and Labeling Time Stamps of Total Outlier Metric Values

Processes and systems construct a total outlier metric from the outlier and normal metric values of the metrics of the complex computational system. A total outlier metric of a complex computational system is given by:

TO=(TOₖ)ₖ₌₁^{N}=(TO(tₖ))ₖ₌₁^{N} (20a)
where TOₖ is a total outlier metric value at a time stamp tₖ.
   Each total outlier metric value is computed as a sum of outlier indicators as follows:

$${TO}_{k} = {\sum }_{j = 1}^{M} {w}_{j} {i}_{j} ( {t}_{k} ) \qquad ( 20 b )$$

where
   iⱼ(tₖ) an outlier indicator
   of the j-th metric at the time stamp tₖ; and
   wⱼ is a numerical metric weight assigned to the j-th metric.
      In certain implementations, the metric weight may be set to one (i.e., wⱼ=1). In other implementations, the metric weight may be used to give certain metrics greater influence in the total outlier metric than other metrics. For example, in computing a total outlier metric for a server computer, CPU and memory metrics may be given greater weight than the error rate of a VM running on the server computer.

A sequence of outlier indicators (iⱼ(tₖ))ₖ₌₁^{N} is determined for each of the M metrics of the complex computational system. In one implementation, each outlier indicator is given by

$${i}_{j} ( {t}_{k} ) = \{ \begin{matrix}1 & if {x}_{k}^{( j )} is an outlier \\ 0 & if {x}_{k}^{( j )} is normal\end{matrix} \qquad ( 21 )$$

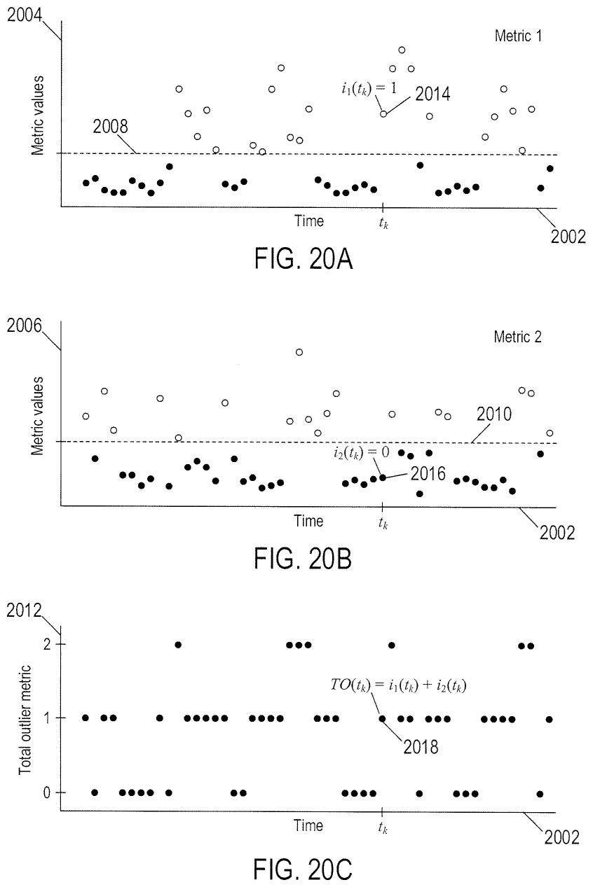

FIGS. 20A-20C show an example of a total outlier metric determined from two metrics. FIGS. 20A and 2B show plots of example first and second metrics, respectively. Horizontal axes 2002 represent a historical time window. Vertical axis 2004 represents a range of metric values for a first metric. Vertical axis 2006 represents a range of metric values for a second metric. In FIG. 20A, dashed line 2008 represents an upper bound that separates normal metric values, represented by solid dots, from outlier metric values, represented by open dots. In FIG. 20B, dashed line 2010 represents an upper bound that separates normal metric values, represented by solid dots, from outlier metric values, represented by open dots. FIG. 20C shows a plot of an example total outlier metric obtained from the metrics illustrated in FIGS. 20A and 20B. Vertical axis 2012 represents a range of total outlier metric values. In FIG. 20C, each total outlier metric value is determined by assigning an outlier indicator for each metric value in FIGS. 20A and 20B according to Equation (21) followed by summing the outlier indicators according to Equation (20b) to obtain total outlier metric values in FIG. 20C. In FIG. 20A, because metric value 2014 at time stamp tₖ is an outlier, the corresponding outlier indicator at time stamp tₖ is assigned the value one (i₁(tₖ)=1). In FIG. 20B, because metric value 2016 at time stamp tₖ is normal, the corresponding outlier indicator at time stamp tₖ is assigned the value zero (i₂(tₖ)=0). In FIG. 20C, the total outlier metric value 2018, TO(tₖ)=1, at the time stamp tₖ is computed as the sum of the outlier indicators i₁(tₖ) and i₂(tₖ).

In other implementations, each outlier indicator is given by

$${i}_{j} ( {t}_{k} ) = \{ \begin{matrix}c & if {x}_{k}^{( j )} is an outlier \\ 0 & if {x}_{k}^{( j )} is normal\end{matrix} \qquad ( 22 )$$

where c is a critical-level parameter.
   The value of the critical-level parameter assigned to an outlier indicator may be determined by the magnitude of the corresponding outlier metric value. The range of metric values above an upper bound, or below a lower bound, may be partitioned into criticality intervals. Each criticality interval corresponds to a different criticality level with the criticality increasing with increasing distance from the upper or lower bounds.

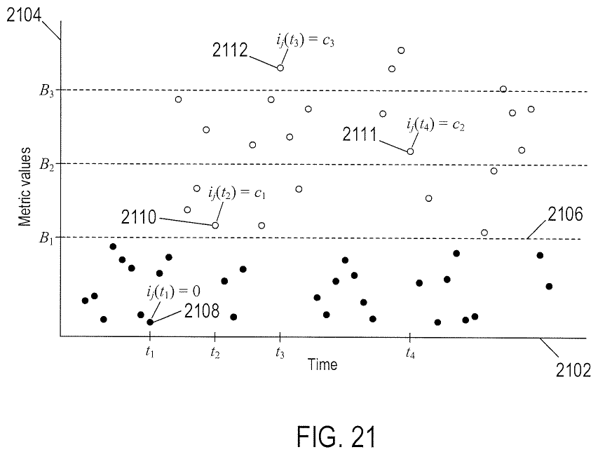

FIG. 21 shows a plot of example metric values of a metric. Horizontal axes 2102 represent a historical time window. Vertical axis 2004 represents a range of metric values for the metric. Dashed line 2106 represents an upper bound that separates normal metric values, represented by solid points, from outlier metric values, represented by open points. In the example of FIG. 21, a value B₁ corresponds to the upper bound 2106. The range of metric values greater than the upper bound 2106 is partitioned into three criticality intervals: B₁<xₖ^{(j)}≤B₂, B₂<xₖ^{(j)}≤B₃, and B₃<xₖ^{(j)} with corresponding critical-level parameters denoted by c₁, c₂, and c₃. The critical-level parameters may be selected so that c₁<c₂<c₃, with c₁ corresponding to a low-risk performance problem, c₂ corresponding to a medium-risk performance problem, and c₃ corresponding a high-risk performance problem. In other words, the critical-level parameters may be selected to give greater value to larger outlier metric values than to smaller outlier metric values because it may be assumed that the farther a metric value is away from an upper or a lower bound, the greater the impact of the abnormal behavior represented by the outlier. In FIG. 21, outlier indicators that correspond to normal metric values less than B₁ are assigned the value zero. Outlier indicators of corresponding metric values that lie within the criticality interval B₁<xₖ^{(j)}≤B₂ are assigned the value c₁ as an indication of a low-risk performance problem. Outlier indicators of corresponding metric values that lie within the criticality interval B₂<xₖ^{(j)}≤B₃ are assigned the value c₂ as an indication of a medium-risk performance problem. Outlier indicators of corresponding metric values that lie within the criticality interval B₃<xₖ^{(j)} are assigned the value c₃ as an indication of a high-risk performance problem. FIG. 21 shows examples of four outlier indicators iⱼ(t₁), iⱼ(t₂), iⱼ(t₃), and iⱼ(t₄) assigned values for a normal metric value 2108 and outlier metric values 2110-2112 in each of the three criticality levels.

Processes and systems determine upper and/or lower bounds to distinguish between outlier and normal total metric values of the total outlier metric. The upper and/or lower bounds for the total outlier metric may be obtained using any one of the techniques used to identify outlier and normal metric values of the metrics described above with reference to FIGS. 18A-19C. Processes and systems label time stamps of the total outlier metric values as normal or abnormal according to whether the corresponding total outlier metric values are located outside the upper and/or lower bounds of the total outlier metric.

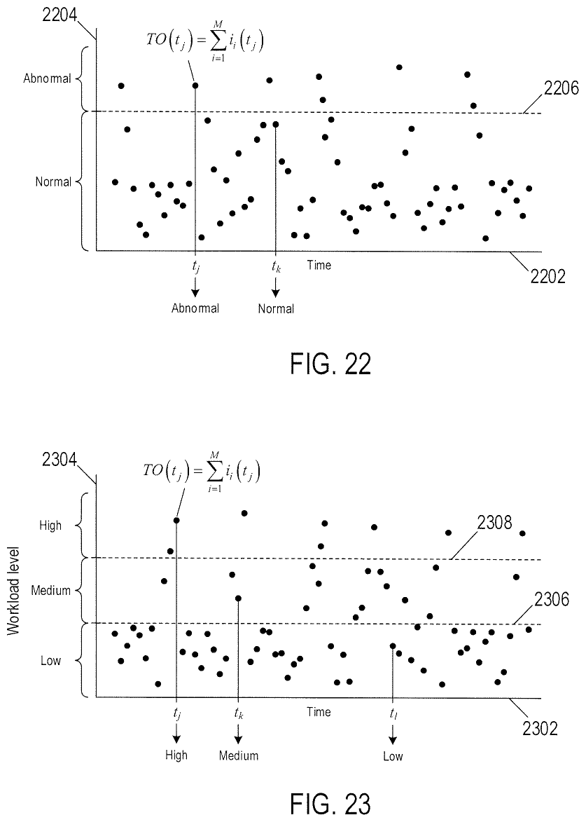

FIG. 22 shows an example plot of a total outlier metric computed from M metrics of a complex computational system. Horizontal axis 2202 represents a historical time window. Vertical axis 2204 represents a range of total outlier metric values. Dashed line 2206 represents an upper bound. In one implementation, the upper bound 2206 may be given by Rμ_{TO}, where μ_{TO} is the mean of the total outlier metric values of the total outlier metric, and R is a number (e.g., R=3, 3.5, 4, or 5). In another implementation, the upper bound 2206 may be determined by the whisker's method in which the upper bound is given by q_{0.75}+Qiqr, where q_{0.75} is the third quartile of the total outlier metric values, iqr is the interquartile range, and Q is a number. Time stamps of total outlier metric values that are greater than the upper bound 2206 are labeled as abnormal. For example, time stamp tⱼ is labeled abnormal. Time stamps of total outlier metric values that are less than the upper bound 2206 are labeled as normal. For example, time stamp tₖ is labeled normal.

In other implementations, processes and systems may label time stamps of total outlier metric values of a total outlier metric as corresponding to a workload level for the complex computational system. In still other implementations, processes and systems may label time stamps of total outlier metric values of a total outlier metric as corresponding to a risk of danger associated with abnormal behavior of the complex computational system.

FIG. 23 shows an example plot of a total outlier metric computed from M metrics of a complex computational system. Horizontal axis 2302 represents a historical time window. Vertical axis 2304 represents a range of total outlier metric values. Dashed line 2306 represents a boundary between low and medium workload levels for the complex computational system. Dashed line 2308 represents a boundary between medium and high workload levels of the complex computational system. Time stamps of total outlier metric values that are less than the boundary 2306 are labeled as low workload and correspond to times when the workload of the complex computational system is low. Time stamps of total outlier metric values between the boundaries 2306 and 2308 are labeled as medium workload and correspond to times when the workload of the complex computational system is medium. Time stamps of total outlier metric values greater than the boundary 2308 are labeled as high workload and correspond to times when the workload for the complex computational system is high. For example, time-stamp labels for the time stamps tⱼ, tₖ, and tₗ are high, medium, and low workloads of the complex computational system. Because high workloads may be associated with performance problems of the complex computational system, the boundary 2308 may be set to an upper bound that separates abnormal and normal total outlier metric values, as described above with reference to FIG. 22.

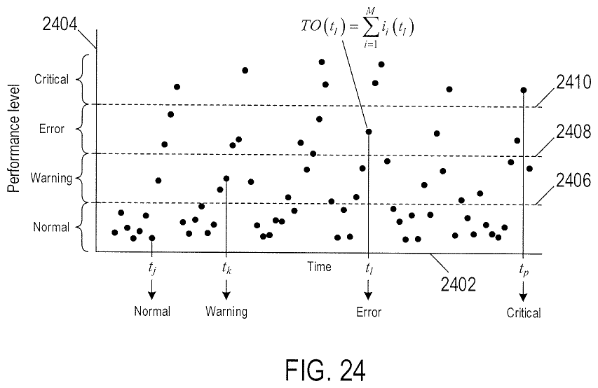

FIG. 24 shows an example plot of a total outlier metric computed from M metrics of a complex computational system. Horizontal axis 2402 represents a historical time window. Vertical axis 2404 represents a range of total outlier metric values. Dashed lines 2406, 2408, and 2410 represent boundaries between a normal level and three risk levels from abnormal behavior of the complex computational system. Time stamps of total outlier metric values less than the boundary 2306 are labeled as normal. Time stamps of total outlier metric values between the boundaries 2406 and 2408 are labeled with a warning, which represents a low risk of abnormal behavior of the complex computational system. Time stamps of total outlier metric values between the boundaries 2408 and 2410 are labeled with an error, which represents a medium risk of abnormal behavior of the complex computational system. Time stamps of the total outlier metric values greater than the boundary 2410 are labeled critical, which corresponds to a high risk of abnormal behavior of the complex computational system. For example, time-stamp labels for the time stamps tⱼ, tₖ, tₗ, and tₚ are normal, warning, error, and critical.

### Generating Rules for Identifying the State of a Complex Computational System

Labeled time stamps of a total outlier metric correspond to time stamps of the M metrics used to form the total outlier metric. Processes and systems train a decision-tree model for detecting the run-time state of a complex computational system based the label time stamps of M metric used to form the total outlier metric. A trained decision tree provides rules for determining the run time state of the complex computational system. Techniques for training a decision-tree model and obtaining rules for determining the run-time state of the complex computational system include iterative dichotomiser 3 (“ID3”) decision tree learning, C4.5 decision tree learning, and C5.0 boot strapping decision tree learning.

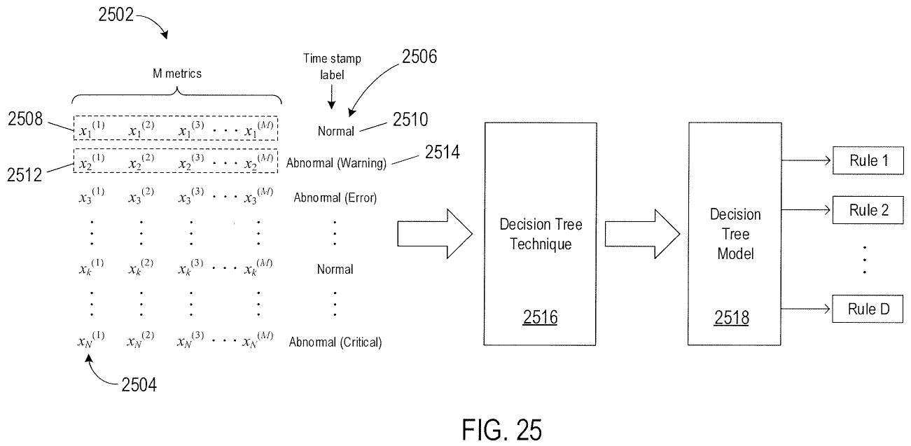

FIG. 25 shows an example of a decision tree technique used to generate a decision-tree model based on the metrics {uⱼ}ⱼ₌₁^{M} and the labeled time stamps. The metrics {uⱼ}ⱼ₌₁^{M} are represented by a dataset 2502. Each column of the dataset 2502 comprises the metric values of one of the metrics {uⱼ}ⱼ₌₁^{M}. For example, column 2504 contains the metric values in the metric u₁=(xᵢ⁽¹⁾)ᵢ₌₁^{N}. Column 2506 contains the time-stamp labels of the time stamps obtained as described above with reference to FIGS. 22-24. For example, row 2508 contains metric values of the metrics {uⱼ}ⱼ₌₁^{M} with the same time stamp t₁ when the complex computational system exhibited normal behavior with time-stamp label “Normal” 2510. On the other hand, row 2512 contains metric values of the metrics {uⱼ}ⱼ₌₁^{M} at the time stamp t₂ when the complex computational system exhibited abnormal behavior as indicated by time-stamp label “Abnormal” 2514. Block 2516 represents the computation operations carried out by a decision tree technique. As shown in FIG. 25, the dataset of M metrics and time-stamp labels are input to the decision tree technique 2516 to train a decision-tree model 2518. The decision-tree model 2518 provides a set of rules identified as Rules 1-D for classifying the state of the complex computational system.

As described above with reference to FIGS. 23-24, time-stamp labels are not limited to a binary choice between normal and abnormal states. In other implementations, the time-stamp labels may identify the state of the complex computational system. For example, in FIG. 25, rather than inputting “Normal” and “Abnormal” for the time-stamp labels, the time-stamp labels may be “Normal,” “Warning,” “Error,” and “Critical,” as represented in parentheses, or low, medium and high in reference to the workloads of the complex computational system.

The decision-tree model 2518 may be displayed in a flow-chart structure in which each node denotes a test of an attribute of a particular metric, each branch represents an outcome of a test (e.g., a test threshold value), and each leaf is a state classification label (i.e., time-stamp label) for the complex computational system. The root node is a test of an attribute that best classifies the metrics. In other words, the root node is a test of an attribute with the highest information gain. The leaf nodes are the state classification labels (i.e., time-stamp labels).

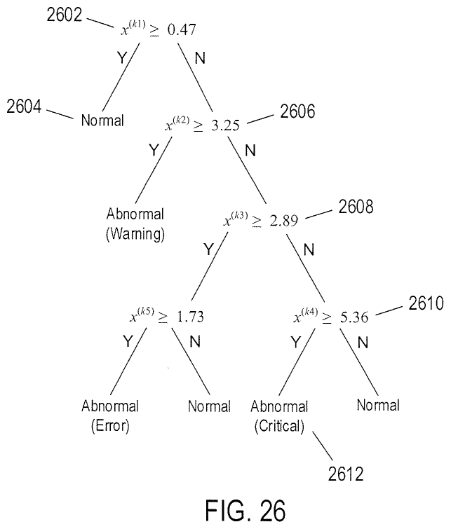

FIGS. 26 show an example of a decision-tree model obtained from a decision tree technique. In the example of FIG. 26, five different metrics denoted by x^{(k1)}, x^{(k2)}, x^{(k3)}, x^{(k4)}, and x^{(k5)} are used to determine the normal or abnormal state of a complex computational system. The root node is a test for the metric with the largest entropy. When the metric value of the metric x^{(k1)} is greater than 0.47 at the test node 2602, the complex computational system is in a normal state 2604. On the other hand, the complex computational system is in an abnormal state, when the metric value of the metric x^{(k1)} is less than 0.47 at the test node 2602, the metric value of the metric x^{(k2)} is greater than 3.25 at the test node 2606, the metric value of the metric x^{(k3)} is less than 2.89 at the test node 2608, and the metric value of the metric x^{(k4)} is greater than 5.36 at the test node 2610. When time-stamp labels identify the specific type of abnormal state are used to determine the decision tree model, as describe above with reference to FIGS. 23-24, the decision-tree model may be used to specifically classify the states of the complex computational system. For example, the specific classification states of the complex computational system may be “Normal,” “Warning,” “Error,” and “Critical,” as represented in parentheses.

Different paths of the decision-tree model 2518 from the root node to a leaf node (i.e., classification state) may be used to define rules for classifying the run-time state of the complex computational system. A rule obtained from the decision-tree model 2518 may be associated with a single metric, or a rule may be associated with various different metrics. Violation of certain rules may be an indication of an abnormal state of the complex computational system. The rules obtained from the decision-tree model 2518 in FIG. 25 may be used to identify abnormal behavior of the complex computational system in run-time metric values of the metrics {μⱼ}ⱼ₌₁^{M}. Depending on the type of rule violation, processes and systems may generate an alert identifying the abnormal state of the complex computational system.

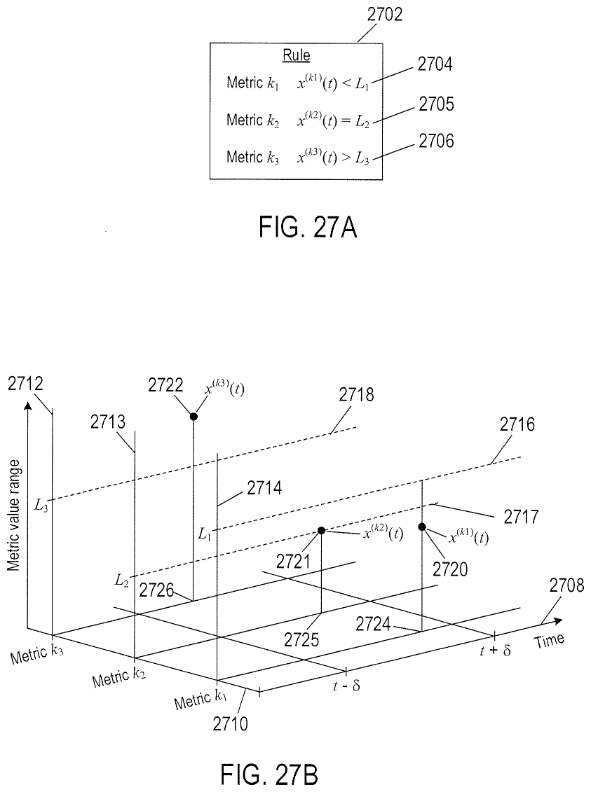

FIGS. 27A-27B show an example of a rule 2702 used to classify the state of a complex computational system. In FIG. 27A, the rule 2702 comprises three conditions 2704-2706 for three metrics x^{(k1)}, x^{(k2)} and x^{(k3)}. The conditions have corresponding test thresholds L₁, L₂, and L₃ associated with three metrics x^{(k1)}, x^{(k2)} and x^{(k3)}. In one implementation, run-time metric values of the metrics may be time synchronized to a general set of uniformly spaced time stamps, as described above with reference to FIG. 16B. When synchronized run-time metric values x^{(k1)}(t), x^{(k2)}(t), and x^{(k3)}(t) satisfy the three conditions 2704-2706, respectively, the rule is violated and an alert is generated identifying the abnormal state of the complex computational system.

In an alternative implementation, the metrics may be unsynchronized. When run-time metric values x^{(k1)}(t), x^{(k2)}(t), and x^{(k3)}(t) satisfy the three conditions 2704-2706, respectively, for corresponding time stamps located in an interval [t−δ, t+δ], the rule is violated and an alert is generated identifying the abnormal behavior of complex computational system. Note that the time stamp t of the run-time metric values x^{(k1)}(t), x^{(k2)}(t), and x^{(k3)}(t) is not intended to imply that the metric values have the same time stamp. The run-time metric values x^{(k1)}(t), x^{(k2)}(t), and x^{(k3)}(t) may have been generated by different metric sources at different time stamps. The value of δ may be selected so that the interval [t−δ, t+δ] covers a range of time stamps of the run-time metric values x^{(k1)}(t), x^{(k2)}(t), and x^{(k3)}(t). FIG. 27B shows a plot of run-time metric values x^{(k1)}(t), x^{(k2)}(t), and x^{(k3)}(t) that satisfy the three conditions 2704-2706 and have different time stamps in an interval [t−δ, t+δ]. Axis 2708 represents time. Axis 2710 represents the metrics k1, k2, and k3. Vertical axes 2712-2714 represent the ranges of the metric values. Dashed lines 2716-2718 represent the thresholds L₁, L₂, and L₃. Solid points 2720-2722 represent run-time metric values x^{(k1)}(t), x^{(k2)}(t), and x^{(k3)}(t) that violate the rule 2702 with time stamps 2724-2726 in the time interval [t−δ, t+δ], thereby triggering an alert identifying the abnormal state of the complex computational system.

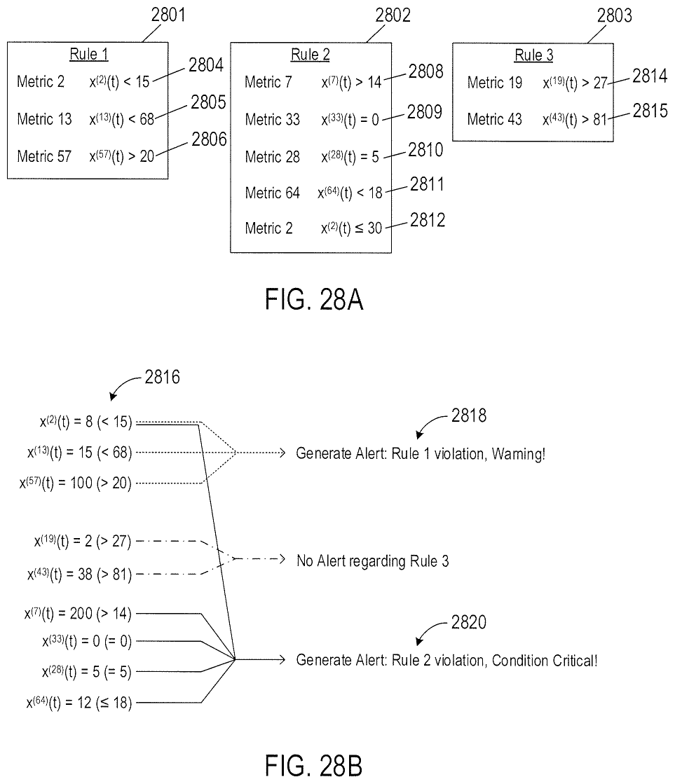

FIGS. 28A shows three example rules output from the decision tree technique described above with reference to FIG. 25. The three example rules are identified as Rule 1 2801, Rule 2 2802, and Rule 3 2803. Rule 1 comprises three conditions 2804-2806 regarding run-time metric values for metrics 6, metric 11, and metric 68. When the three conditions 2804-2806 are satisfied for the three run-time metric values of corresponding metric 2, metric 13, and metric 57 at approximately the same time stamp, Rule 1 is violated and an alert is generated indicating the complex computational system is behaving abnormally due to a Rule 1 violation. Rule 2 comprises five conditions 2808-2812 regarding run-time metric values for metric 7, metric 33, metric 28, metric 64, and metric 2. When the conditions 2808-2812 are satisfied for run-time metric values of corresponding metrics 7, 33, 28, 64, and 2, Rule 2 is violated and an alert is generated indicating the complex computational system is behaving abnormally due to a Rule 2 violation. Rule 3 comprises two conditions 2814 and 2815 regarding run-time metric values for metric 19 and metric 43. When the two conditions 2814 and 2815 are satisfied for two run-time metric values of the corresponding metrics 19 and 43 at about the same time stamp, Rule 3 is violated and an alert is generated indicating the complex computational system is behaving abnormally due to a Rule 3 violation.

FIG. 28B shows an example of the rules Rule 1, 2, and 3 applied to run-time metric data generated by uncorrelated metrics 2, 7, 13, 19, 28, 33, 43, 57, and 64. FIG. 28B shows examples of run-time metric values 2816 for each of the metrics 2, 7, 13, 19, 28, 33, 43, 57, and 64 generated at approximately the same time stamp t. For example, x⁽²⁾(t)=8 is the metric value for the metric 6 generated at the time stamp t. The conditions for the rules are displayed next to each of the run-time metric values. According to Rule 1 in FIG. 28A, the metric values x⁽²⁾(t)=8, x⁽¹³⁾(t)=11, and x⁽⁵⁷⁾(t)=100 satisfy the three conditions for a Rule 1 violation, which triggers an alert 2818. The example of FIG. 28B reveals that the run-time metric values x⁽¹⁹⁾(t)=2 and x⁽⁴³⁾(t)=38 of metrics 19 and 43 do not violate Rule 3, which does not trigger an alert. The run-time metric values x⁽²⁾(t)=8, x⁽⁷⁾(t)=200, x⁽³³⁾(t)=0, x⁽²⁸⁾(t)=5, and x⁽⁶⁴⁾(t)=12 for metrics 2, 7, 33, 28, and 64 violate Rule 2, which triggers an alert 2820. The alerts may be generated on an administration console to notify IT administrators of the abnormal behavior of the object.

Given the many different types of abnormal states of complex computational systems, IT administrators may have developed different remedial measures for correcting the various different abnormal states. When processes and systems identify a rule violation that triggers an alert identifying the abnormal state of the complex computational system, the processes and systems may also generate instructions for correcting the abnormal state or execute preprogrammed computer instructions that correct the abnormal state. For example, if an object is a virtual object and an alert is generated indicating inadequate virtual processor capacity, remedial measures that increase the virtual processor capacity of the virtual object may be executed or the virtual object may be migrated to a different server computer with more available processing capacity.

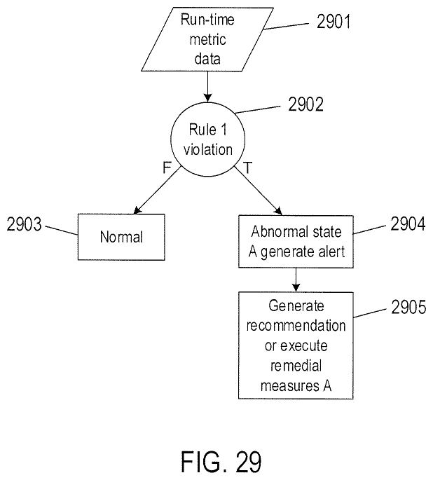

FIG. 29 shows an example graph of operations executed in response to a rule violation. Nodes represent a run-time metric value, Rule 1, and operations that are executed if Rule 1 is violated. Directional arrows represent directed edges that represent the relationships between nodes. Truth values are represented by T and F and are used to represent whether the rule has been violated, as described above with reference to FIGS. 28A-28B. Node 2901 represents run-time or newly identified metric value. Node 2902 represents violation of Rule 1. Node 2903 represents normal operation of the resource. If Rule 1 is violated, node 2904 represents generating an alert that identifies the type of rule violation, denoted by Abnormal state A. For example, Abnormal state A may represent an excessive error rate. Node 2905 represents generating a recommended remedial measure A that corrects Abnormal state A or automatically executes remedial measure A.

In other instances, certain abnormal behaviors may be identified by a combination of two or more rule violations. Each combination of rule violations may have different associated remedial measures for correcting the problem. For example, a computer server that has become compute bound may be identified when rules associated with CPU response time and memory usage are violated. A single alert may be generated indicating the server computer has become compute bound. Remedial measures may include restarting the server computer or migrating virtual objects to other server computers to reduce the workload at the server computer.

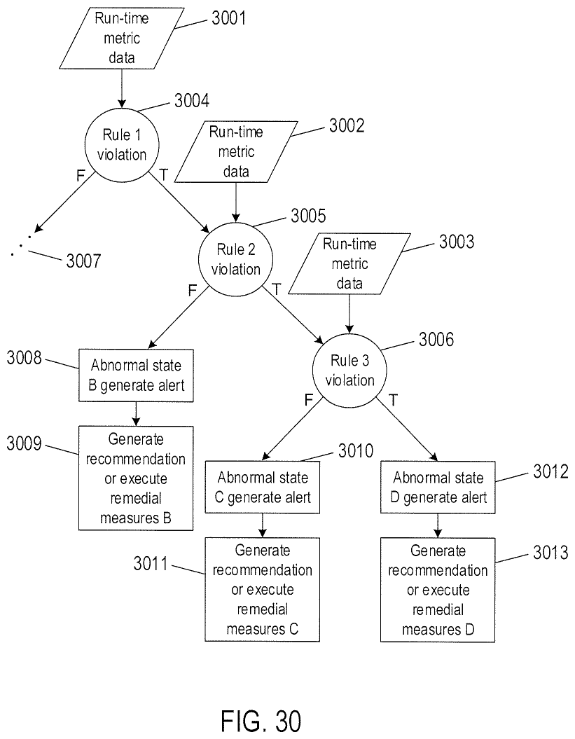

FIG. 30 shows an example graph of operations that may be executed in response to different combinations of rule violations. Nodes 3001-3003 represents run-time metrics values for the metrics. Nodes 3004-3006 represent rules denoted by Rule 1, Rule 2, and Rule 3. Ellipsis 3007 represents other nodes of the graph not shown. Nodes 3008, 3010, and 3012 represent three different types of alerts associated with three different types of abnormalities identified as Abnormal state B, Abnormal state C, and Abnormal state D. For example, Abnormal state B may represent excessive virtual CPU usage, Abnormal state C may represent a combination of excessive virtual CPU and virtual memory usage, and Abnormal state D may represent a combination of excessive virtual CPU usage, virtual memory usage, and virtual data storage usage. Nodes 3009, 3011, and 3013 represent three different types of remedial measures identified as remedial measure B, remedial measure C, and remedial measure D. For example, remedial measure B may represent increasing virtual CPU, remedial measure C may represent increasing virtual CPU and virtual memory, and remedial measure D may represent migrating the virtual object to a different server computer. As shown in FIG. 42, if Rule 1 is violated and Rule 2 is not violated, node 3008 generates an alert identifying abnormal state B. Node 3009 generates recommended remedial measure B or automatically executes remedial measure B. If Rules 1 and 2 are violated and Rule 3 is not violated, node 3010 generates an alert identifying Abnormal state C. Node 3011 generates recommended remedial measure C or automatically executes remedial measure C. If Rules 1, 2, and 3 are violated, node 3012 generates an alert identifying Abnormal state D. Node 3013 generates recommended remedial measure D or automatically executes the remedial measures D.

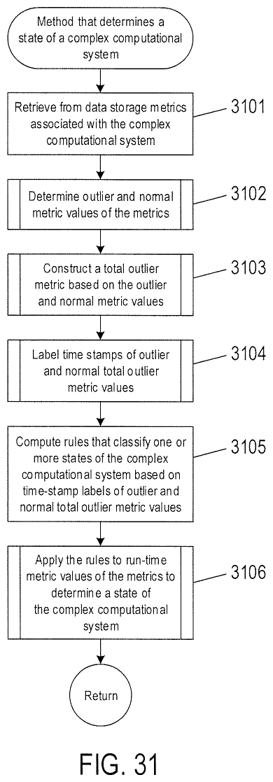

The methods described below with reference to FIGS. 31-36 are stored in one or more data-storage devices as machine-readable instructions that when executed by one or more processors of a computer system, such as the computer system shown in FIG. 1, determine the state of a complex computational system of a distributed computing system.

FIG. 31 is a flow diagram illustrating an example implementation of a method that determines a state of a complex computational system of a distributed computing system. In block 3101, metrics associated with the complex computational system over an historical time window are retrieved from data storage. In block 3102, a “determine outlier and normal metric values of the metrics” procedure is performed. In block 3103, a “construct a total outlier metric based the outlier and normal metric values” procedure is performed. In block 3104 a “label time stamps of outlier and normal total outlier metric values” procedure is performed on the total outlier metric over the historical time window. In block 3105 rules that classify one or more states of the complex computational system are computed based on time-stamp labels assigned to time stamps of outlier and normal total outlier metric values of the total outlier metric as described above with reference to FIG. 25. In block 3106, an “apply the rules to run-time metric values of the metrics to determine a state of the complex computational system” procedure is performed.

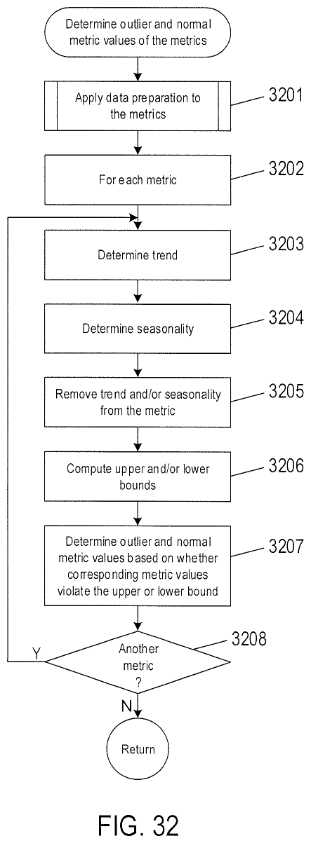

FIG. 32 is a flow diagram illustrating an example implementation of the “determine outlier and normal metric values of the metrics” step referred to in block 3102 of FIG. 31. In block 3201, an “apply data preparation to the metrics” process is performed to delete constant and nearly constant metrics. A for loop in block 3202 repeats the computational operations represented by blocks 3203-3207 for each metric. In block 3203, a trend component of a metric is determined as described above with reference to Equations (6a)-(6d). In block 3204, a seasonal component of the metric is determined as described above. In block 3205, the trend and/or seasonal component is subtracted from the metric as described above with reference to Equation (8). In block 3206, upper and/or lower bounds of the metric are computed as described above. For example, the upper or lower bounds may be computed as described above with reference to FIG. 18B. The upper or lower bounds may be computed using whisker's technique. The upper or lower bounds may be computed as described above with reference to FIGS. 19A-19C. In block 3207, outlier and normal metric values are determined based on whether corresponding metric values violate the upper or lower bound. In decision block 3208, blocks 3203-3207 are repeated for another metric.

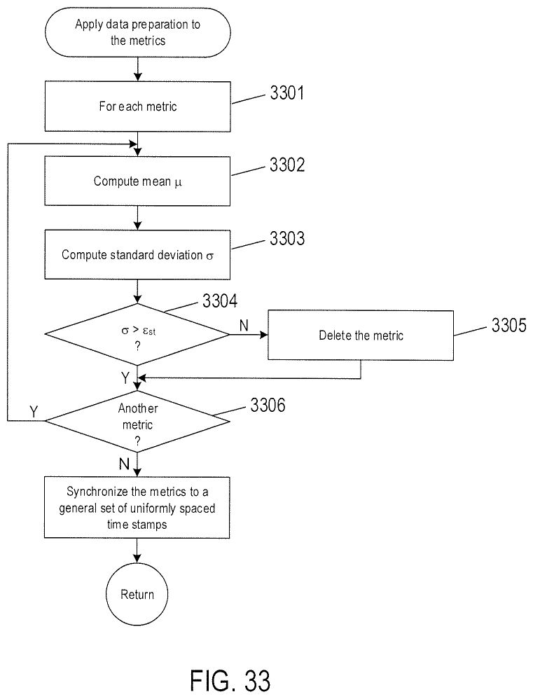

FIG. 33 is a flow diagram illustrating an example implementation of the “apply data preparation to the metrics” step referred to in block 3201 of FIG. 32. A loop beginning with block 3301 repeats the operations represented by blocks 3302-3306 for each metric associated with the object. In block 3302, a mean is computed for the metric. In block 3303, a standard deviation is computed based on the metric and the mean computed in block 3302. In block 3304, when the standard deviation is less than a standard deviation threshold, control flows to block 3305. In block 3305, the metric is deleted from the metrics and not used below. In block 3306, the operations represented by blocks 3302-3305 are repeated for another metric. In block 3307, each metric is synchronized to a general set of uniformly spaced time stamps, as described above with reference to FIG. 16B.

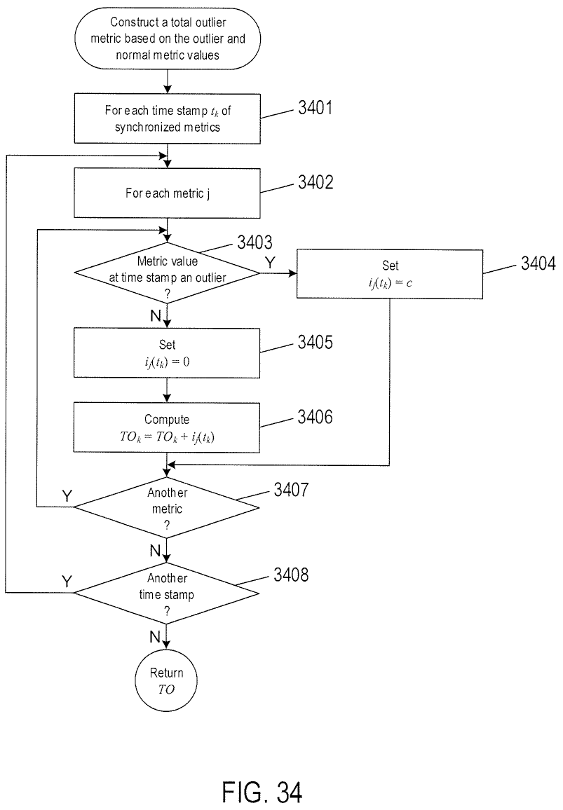

FIG. 34 is a flow diagram of an example implementation of the “construct a total outlier metric based on the outlier and normal metric values” step referred to in block 3103 of FIG. 31. A loop beginning with block 3401 repeats the computational operations represented by blocks 3402-3407 for each time stamp in the historical time window. A loop beginning with block 3402 repeats the computations operations represented by blocks 3403-3406 for each metric. In decision block 3403, when a metric value of the metric at the time stamp is greater than an upper bound for the metric (or a lower bound for the metric), control flows to block 3404. Otherwise control flows to block 3405. In block 3404, an outlier indicator is assigned a numerical value c. In certain implementations, the value c may be set to 1, according to Equation (21). While in other implementations, the value c may be set as described above with reference to Equation (22) and represented in FIG. 21. In block 3405, the outlier indicator is assigned the value zero. In decision block 3407, the computational operations represented by blocks 3403-3406 are repeated for another metric. In decision block 3408, the computational operations represented by blocks 3402-3407 are repeated for another time stamp in the historical time window.

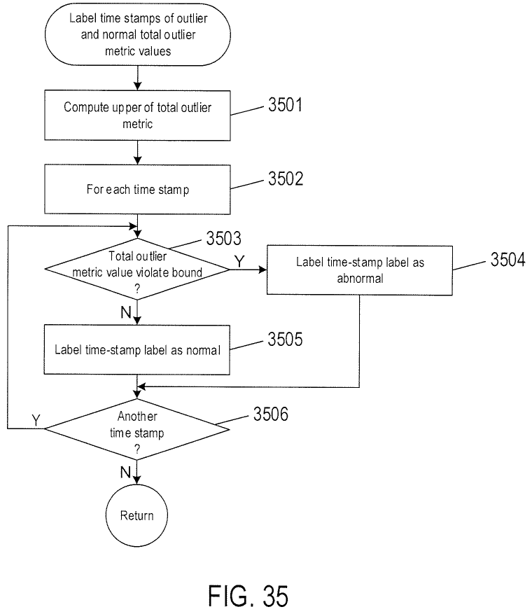

FIG. 35 is a flow diagram of an example implementation of the “label time stamps of outlier and normal total outlier metric values” step referred to in block 3104 of FIG. 31. In block 3501, an upper bound is computed for the total outlier metric as described above with reference to FIG. 22. A loop beginning with block 3502 repeats the computational operations represented by blocks 3503-3506 for each time stamp in the historical time window. In decision block 3503, when a total outlier metric value is greater than the upper bound, control flows to block 3504. Otherwise, control flows to block 3505. In block 3504, the time stamp of the total metric value is assigned an abnormal time-stamp label, as described above with reference to FIG. 22. In block 3505, the time stamp of the total metric value is assigned a normal time-stamp label, as described above with reference to FIG. 22. In decision block 3506, the computational operations represented by blocks 3503-3505 are repeated for another time stamp in the historical time window.

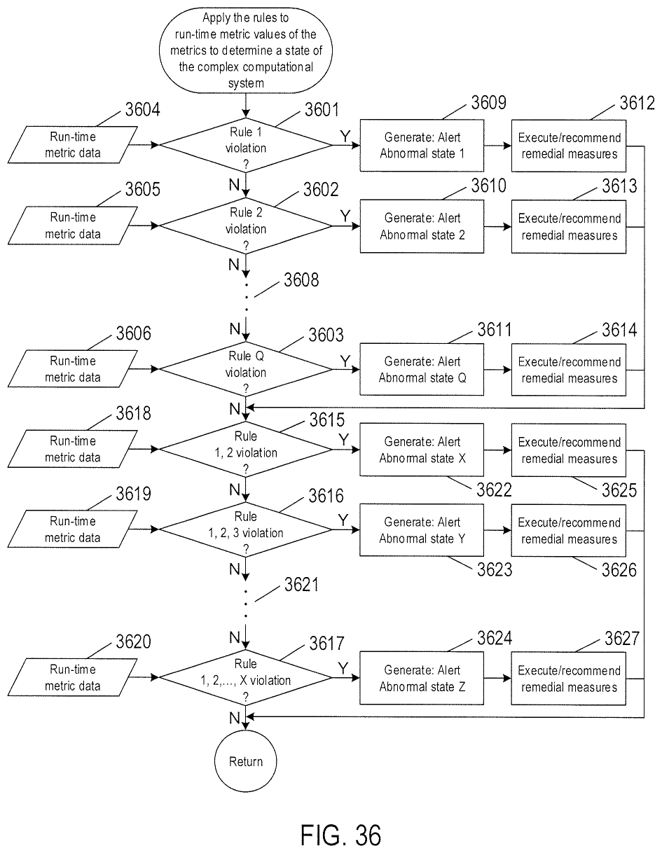

FIG. 36 is a flow diagram of an example implementation of the “apply the rules to run-time metric values of the metrics to determine a run-time state of the complex computational system” step referred to in block 3106 of FIG. 31. In decision blocks, 3601, 3601, and 3603 rules are applied to run-time metric data 3604, 3605, and 3606, respectively. Ellipsis 3608 represents rules (not shown) applied to the run-time metric data. When one of the rules represented by decision blocks 3601, 3602, and 3603 are violated, control flows to corresponding blocks 3609, 3610, and 3611, in which a corresponding alert identifying the abnormal state associated with the rule violation is generated as described above with reference to FIGS. 29 and 30. In blocks 3612, 3613, and 3614, remedial measures are provided or executed to correct the abnormal behavior of the object. In decision blocks, 3615, 3616, and 3617 combinations of rules are applied to the run-time metric data 3618, 3619, and 3620, respectively. Ellipsis 3621 represents combinations of rules (not shown) associated with combinations of run-time metric data. When one of the rules represented by decision blocks 3615, 3616, and 3617 are violated, control flows to corresponding blocks 3622, 3623, and 3624, in which a corresponding alert identifying the abnormal state associated with combinations of rule violations is generated as described above with reference to FIG. 30. In blocks 3625, 3626, and 3627, remedial measures are provided or executed to correct the abnormal behavior of object.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. In a process that determines a state of a complex computational system of a distributed computing system from metrics associated with the complex computational system, the specific improvement comprising:
determining outlier and normal metric values of the metrics recorded in a historical time window;
constructing a total outlier metric based on the outlier and normal metric values of the metrics;
labeling time stamps of outlier and normal total outlier metric values of the total outlier metric over the historical time window, each time-stamp label identifying a normal or abnormal state of the complex computation system;
computing one or more rules for classifying normal and abnormal states of the complex computational system over the historical time window based on the time-stamp labels;
applying the rules to run-time metric values of the metrics to determine a state of the complex computational system; and
generating an alert when the state indicates abnormal behavior of the complex computational system, thereby enabling identification and correction of the abnormal behavior.

2. The process of claim 1 wherein determining the outlier and normal metric values of the metrics comprises:
for each metric
computing a standard deviation of metric values of the metric, and
discarding the metric if the corresponding standard deviation is less than a standard deviation threshold; and
for each metric with a standard deviation greater than the standard deviation threshold
detrending the metric,
seasonally adjusting the metric,
computing an upper bound or a lower bound for the metric, and
determining the outlier and normal metric values based on whether corresponding metric values violate the upper bound or the lower bound.

3. The process of claim 1 further comprising synchronizing the metrics to a general sequence of time stamps.

4. The process of claim 1 wherein constructing the total outlier metric comprises:
for each metric
if a metric value in the historical time window is an outlier, assigning a non-zero parameter to an outlier indicator associated with the metric, and
if the metric value in the historical time window is normal, assigning zero to the outlier indicator associated with the metric; and
for each time stamp
summing the outlier indicators across the metrics to foam a total outlier metric value of the total outlier metric.

5. The process of claim 1 wherein labeling time stamps of outlier and normal total outlier metric values of the total outlier metric over the historical time window comprises:
computing an upper bound for the total outlier metric over the historical time window; and
for each time stamp in the historical time window
if a total outlier metric value at the time stamp is greater than the upper bound, assigning an abnormal time-stamp label to the time stamp, and
if a total outlier metric value at the time stamp is less than the upper bound, assigning a normal time-stamp label to the time stamp.

6. The process of claim 1 wherein computing one or more rules for classifying the normal and abnormal states of the complex computational system over the historical time window comprises computing a decision-tree model based on the metrics and the time-stamp labels, wherein each path of the decision-tree model.

7. The process of claim 1 further comprising executing remedial measures in response to the alert.

8. A computer system that determines a state of a complex computational system of a distributed computing system, the system comprising:
one or more processors;
one or more data-storage devices; and
machine-readable instructions stored in the one or more data-storage devices that when executed using the one or more processors controls the system to execute operations comprising:
determining outlier and normal metric values of the metrics recorded in a historical time window;
constructing a total outlier metric based on the outlier and normal metric values of the metrics;
labeling time stamps of outlier and normal total outlier metric values of the total outlier metric over the historical time window, each time-stamp label identifying a normal or abnormal state of the complex computation system;
computing one or more rules for classifying normal and abnormal states of the complex computational system over the historical time window based on the time-stamp labels;
applying the rules to run-time metric values of the metrics to determine a state of the complex computational system; and
generating an alert when the state indicates abnormal behavior of the complex computational system.

9. The computer system of claim 8 wherein determining the outlier and normal metric values of the metrics comprises:
for each metric
computing a standard deviation of metric values of the metric, and
discarding the metric if the corresponding standard deviation is less than a standard deviation threshold; and
for each metric with a standard deviation greater than the standard deviation threshold
detrending the metric,
seasonally adjusting the metric,
computing an upper bound or a lower bound for the metric, and
determining the outlier and normal metric values based on whether corresponding metric values violate the upper bound or the lower bound.

10. The computer system of claim 8 further comprising synchronizing the metrics to a general sequence of time stamps.

11. The computer system of claim 8 wherein constructing the total outlier metric comprises:
for each metric
if a metric value in the historical time window is an outlier, assigning a non-zero parameter to an outlier indicator associated with the metric, and
if the metric value in the historical time window is normal, assigning zero to the outlier indicator associated with the metric; and
for each time stamp
summing the outlier indicators across the metrics to form a total outlier metric value of the total outlier metric.

12. The computer system of claim 8 wherein labeling time stamps of outlier and normal total outlier metric values of the total outlier metric over the historical time window comprises:
computing an upper bound for the total outlier metric over the historical time window; and
for each time stamp in the historical time window
if a total outlier metric value at the time stamp is greater than the upper bound, assigning an abnormal time-stamp label to the time stamp, and
if a total outlier metric value at the time stamp is less than the upper bound, assigning a normal time-stamp label to the time stamp.

13. The computer system of claim 8 wherein computing one or more rules for classifying the normal and abnormal states of the complex computational system over the historical time window comprises computing a decision-tree model based on the metrics and the time-stamp labels, wherein each path of the decision-tree model.

14. The computer system of claim 8 further comprising executing remedial measures in response to the alert.

15. A non-transitory computer-readable medium encoded with machine-readable instructions that implement a method carried out by one or more processors of a computer system to execute operations comprising:
determining outlier and normal metric values of the metrics recorded in a historical time window;
constructing a total outlier metric based on the outlier and normal metric values of the metrics;
labeling time stamps of outlier and normal total outlier metric values of the total outlier metric over the historical time window, each time-stamp label identifying a normal or abnormal state of the complex computation system;
computing one or more rules for classifying normal and abnormal states of the complex computational system over the historical time window based on the time-stamp labels;
applying the rules to run-time metric values of the metrics to determine a state of the complex computational system; and
generating an alert when the state indicates abnormal behavior of the complex computational system.

16. The medium of claim 15 wherein determining the outlier and normal metric values of the metrics comprises:
for each metric
computing a standard deviation of metric values of the metric, and
discarding the metric if the corresponding standard deviation is less than a standard deviation threshold; and
for each metric with a standard deviation greater than the standard deviation threshold
detrending the metric,
seasonally adjusting the metric,
computing an upper bound or a lower bound for the metric, and
determining the outlier and normal metric values based on whether corresponding metric values violate the upper bound or the lower bound.

17. The medium of claim 15 further comprising synchronizing the metrics to a general sequence of time stamps.

18. The medium of claim 15 wherein constructing the total outlier metric comprises:
for each metric
if a metric value in the historical time window is an outlier, assigning a non-zero parameter to an outlier indicator associated with the metric, and
if the metric value in the historical time window is normal, assigning zero to the outlier indicator associated with the metric; and
for each time stamp
summing the outlier indicators across the metrics to form a total outlier metric value of the total outlier metric.

19. The medium of claim 15 wherein labeling time stamps of outlier and normal total outlier metric values of the total outlier metric over the historical time window comprises:
computing an upper bound for the total outlier metric over the historical time window; and
for each time stamp in the historical time window
if a total outlier metric value at the time stamp is greater than the upper bound, assigning an abnormal time-stamp label to the time stamp, and
if a total outlier metric value at the time stamp is less than the upper bound, assigning a normal time-stamp label to the time stamp.

20. The medium of claim 15 wherein computing one or more rules for classifying the normal and abnormal states of the complex computational system over the historical time window comprises computing a decision-tree model based on the metrics and the time-stamp labels, wherein each path of the decision-tree model.

21. The medium of claim 15 further comprising executing remedial measures in response to the alert.
